(19) United States
(12) Patent Application Publication
(10) Pub. No.: US 2001/0019478 A1
(43) Pub. Date: Sep. 6, 2001

(54) Wiring harness producing method, a subassembly device, a cover board, a wire laying board and an apparatus for producing a subassembly

(76) Inventors: Taka Izumi, Yokkaichi-City (JP); Hidetaka Yuri, Yokkaichi-City (JP); Kiyokazu Kurihara, Yokkaichi-City (JP); Hiroaki Yurikusa, Yokkaichi-City (JP); Brendan Vaughan, Yokkaichi-City (JP)

Correspondence Address: CASELLA & HESPOS, 274 MADISON AVENUE, NEW YORK, NY, 10016

(21) Appl. No.: 09/797,312

(22) Filed: Mar. 1, 2001

(30) Foreign Application Priority Data
Mar. 3, 2000 (JP) 2000-058337
Mar. 3, 2000 (JP) 2000-058338
Mar. 29, 2000 (JP) 2000-092170
Dec. 26, 2000 (JP) 2000-395556

(51) Int. Cl. H02B 1/20

(52) U.S. Cl. 361/826

(57) ABSTRACT

A subassembly M is produced on a board 201 of a subassembly line SL in a compressed mode of its layout mode on a wire laying board 11 of a main line ML. The subassembly M in the compressed mode is temporarily held on the board 201. The temporarily held subassembly M is arranged on the wire laying board 11 while being extended to its final mode.

### BACKGROUND OF THE INVENTION

1. Field of the Invention.

The present invention relates to a wiring harness producing method, a subassembly device, a cover board, a wire laying board and an apparatus for producing a subassembly.

2. Description of the Related Art.

Automotive vehicles are being equipped with more and more electronic devices. For example, wiring harnesses with 80-100 circuits often are specified for automotive vehicles. Accordingly, larger wiring harnesses with complicated branch wires have been required.

Complex wiring harnesses often are produced by first making wiring harness subassemblies. The wiring harness small-subassembly production method typically starts with wires that have been connected to terminals. The wiring harness small-subassembly production method then has a connecting step of inserting the terminals into connectors to produce several subassemblies. The method further comprises a wire laying step of arranging the produced subassemblies on a wire laying board of a main line, and a gross assembling step of bundling the arranged subassemblies to form wire groups of a final wiring harness.

Particularly complex wiring harnesses may also require the production of intermediate subassemblies. The intermediate-subassembly method includes a step of combining several subassemblies to form an intermediate assembly and a step of gross assembling intermediate assemblies into a final wiring harness (Japanese Unexamined Patent Publication No. 8-235943).

Either of the above-described methods may require complicated line movements by an operator or unnecessary lay-aside operations during the gross assembly. To avoid these inefficiencies, the modes of the produced subassemblies must conform to the modes at the time of gross assembling. Thus, the subassemblies are produced in the same modes as those at the time of gross assembling according to either of the conventional methods.

Free terminals are those that have not been inserted into a connector at the completion of a subassembly or an intermediate assembly, and that are intended for insertion into a connector during the gross assembly step of the wiring harness assembly process. These free terminals easily can be caught or entangled with other free terminal or wires. Even a single instance where a free terminal is caught can prevent the completion of the wiring harness.

The number of free terminals can be reduced by producing, at one time, a large subassembly with the large number of circuits. However, the production of such a large subassembly at once requires a large work area that conforms to the layout mode of the subassembly. More particularly, the wire laying board for such a large subassembly requires many wire holders. These wire holders typically are U-shaped bar members disposed at specific locations across the wire laying board and oriented in various specific directions. This large complex wire laying board disadvantageously results in a longer wire laying operation for the subassembly and poor operability. Moreover, the efficient transfer of such a large subassembly onto the wire laying board is difficult, and the subassembly transferring step has taken substantial time and labor.

Production of a large subassembly at one time has other inefficiencies as well. Specifically, even one occurrence of wire entanglement makes the gross assembly of the subassemblies impossible. Thus, the mode or layout of the subassembly has been critically important. To avoid entanglement, the subassemblies typically are constructed in conformity with the mode or layout of the final wiring harness. As a result, a wire laying operation for the subassembly production process often is repeated for the gross assembling process. This results in large losses of time and labor. More particularly, many branch wires of the large subassembly are branched off from a main wire and many steps are required to lay the branch wires. The repeated steps increase production costs.

The above-described methods also require the subassemblies to be taped to maintain their layout modes. Such taping also causes an increase in production costs.

In view of the above problems, an object of the present invention is to improve wiring harness and/or subassembly production. In particular, it is an object of the invention to facilitate transfer of a large subassembly produced in a compressed final mode from a subassembly line to a main line and, accordingly, to facilitate the production of the large subassembly. It is also an object of the invention to enable a large subassembly to be arranged easily on the wire laying board of a main line and to make a wiring harness production process significantly more efficient by producing large subassemblies that are easily transferable to a later operation step.

### SUMMARY OF THE INVENTION

A first aspect of the invention relates to a wiring harness producing method for producing subassemblies of a wiring harness in advance and then producing the wiring harness by arranging the produced subassemblies on a wire laying board of a main line. The method comprises producing the subassemblies on one or more boards of subassembly lines in compressed modes of their layout modes of the subassemblies on the wire laying board of the main line. The method then comprises temporarily holding the subassemblies on the boards in the compressed modes by means of a subassembly device. The method further comprises arranging the temporarily held subassemblies on the wire laying board of the main line while developing the compressed modes of the subassemblies into final or layout or decompressed modes or to a mode in which the subassembly substantially corresponds to the state in which it is to be mounted on the wire laying board.

According to another aspect of the invention, there is provided a subassembly device for temporarily holding a subassembly produced on at least one board of a subassembly line and transferring the held subassembly to the wire laying board of the main line. The subassembly device is operative to hold the subassembly in a compressed mode of its layout mode on a wire laying board of a main line. The subassembly device comprises a carrier detachably mountable on the board, and temporarily holding members on the carrier for temporarily holding wires and/or parts (e.g. connectors, protective tubes, terminals, etc.) of the subassembly in the compressed mode. The carrier preferably is a lightweight inexpensive extendable rail. The temporarily holding members can be displaced on the carrier so that the temporarily held subassembly can be developed from its compressed mode to the layout mode on the wire laying board.

The temporary holding members may be connected to one another by coupling members that selectively move the temporary holding members away from each other and selectively permit the temporary holding members to move toward each other. The coupling members may be constructed such that temporary holding members at intermediate positions can be moved merely by moving the temporary holding members at the opposite ends. Thus, the temporary holding members can be developed easily from the compressed mode to the layout mode. In a preferred embodiment, the coupling members are wires, and therefore are lightweight and inexpensive.

According to these aspects of the invention, the subassembly can be produced on the board of the subassembly line in the compressed mode, and the temporarily holding members maintain the compressed mode. The temporarily held subassembly then can be taken out of the subassembly line by detaching the carrier that is mounted detachably on the board of the subassembly line. The detached carrier then can be conveyed to the wire laying board of the main line. Once on the wire laying board, the compressed subassembly can be extended to the final mode by displacing the temporarily holding members on the carrier.

A specific method for producing the subassembly in a compressed mode on the subassembly line may include: sorting the respective branch wires into groups; sorting connectors corresponding to the respective branch wires into the respective groups and arraying them; and then connecting the wires with the corresponding arrayed connectors.

The invention also is directed to a cover board for use with a wire laying board. The wire laying board comprises wire holders for arranging a subassembly that is produced by assembling a plurality of wires in advance. The cover board is provided detachably on the wire laying board to cover certain wire holders that are not needed at a specified stage. Accordingly, the subassembly can be arranged on the wire laying board while the wires of the subassembly are received on the cover board that had been mounted on the wire laying board to cover the certain wire holders. Thus, even if the subassembly is large, the wires of the subassembly are unlikely to get caught by the wire holders, thereby remarkably improving the efficiency of the subassembly arranging operation. The cover board preferably is made from urethane or like relatively lightweight material that can be processed easily. Thus, the cover board can be handled very easily, and can be processed easily into a desired shape.

The cover board may include an exposing portion for exposing the wire holders that are needed to arrange the subassembly along one direction. The exposing portion avoids having the operator move back and forth when arranging the long subassembly from one end to the other. Thus, the subassembly can be arranged by a simple line of movement.

The invention also is directed to subassembly transferring device. The device preferably comprises a coupling mechanism with a plurality of slidable pieces that having substantially the same specifications. The slidable pieces may be mounted for sliding movement in or along the longitudinal direction of a carrier, such as the above-described carrier. A coupling member, such as a wire, is provided for coupling the respective slidable pieces in a manner that permits the sliding pieces to extend and contract freely, and thus to move towards and away from each other. Temporary holding members are fixed detachably to the respective slidable pieces. The above-described subassembly transferring device is very versatile. More particularly, the temporary holding members can be fixed selectively to the slidable pieces so as to correspond to individual subassemblies when several kinds of subassemblies are to be produced. Further, even if some temporary holding members are broken, the subassembly transferring device can continue to be used by exchanging only the broken temporary holding members with new ones, thereby resulting in more efficient maintenance.

The number of the slidable pieces preferably is set to correspond to a subassembly that has a maximum number of wires from among the several of kinds of subassemblies that are to be produced. Thus, the subassembly transferring device can be applied to any subassembly with fewer wires, thereby maximally enhancing the versatility.

The invention also is directed to a wire laying board for a wiring harness. The wire laying board comprises detachable members for detachably holding the carrier of the above described subassembly device or subassembly transferring device. The wire laying board further comprises standing members for holding the detachable members in an elevated position, and preferably a position sufficiently above a wire laying height defined by wire holders to arrange the subassembly from the subassembly transferring device held by the detachable members. According to this aspect of the invention, even if the subassembly is large, the compressed subassembly can be developed easily by one hand and arranged on the wire laying board of the main line by holding the transferring device by the detachable members.

The wire laying board of the invention may comprise at least one cover board as described above, and at least one mounting member for mounting the cover board on a main body of the wire laying board such that the cover board is displaceable between a covering position where it covers the certain wire holders and an exposing position where it exposes all the wire holders. The simply constructed cover board enables the subassembly arranging operation to be performed easily. Hence, operational efficiency can be improved significantly by a small cost.

A holding member may be provided for holding the cover board in the covering position. Such an arrangement enables the holding member to mount the cover board on any wire laying board and the mounted cover board can be handled easily. Accordingly, a production line can be built in which the subassemblies can be arranged easily even if the production line is of the type in which the wire laying boards are conveyed by a conveyor.

The invention also is directed to a wiring harness producing method for producing a subassembly at a subassembly line and then arranging the subassembly on a wire laying board of a main line to produce a processed, preferably substantially final wiring harness. The method comprises sorting the respective branch wires into a plurality of groups based on an operation procedure at the main line, and sorting the connectors corresponding to the respective branch wires for the respective groups and arranging them in or on respective connector holders. The method proceeds by connecting the corresponding wires with the arranged connectors, and temporarily holding the connected wires for the respective groups of the branch wires with a subassembly device as described above for temporarily holding and/or transferring the subassembly.

According to still another aspect of the present invention, there is provided an apparatus for producing a subassembly having a plurality of branch wires and connectors connected with ends of the branch wires in order to produce a wiring harness at a main line. The apparatus comprises at least one board on which a connecting operation for the subassembly is performed. The apparatus also comprises connector holders on the board and adapted to hold the connectors that will form the subassembly. A wire connection instructing mechanism is provided for identifying wires to be connected with contacts of the connector held in or on each connector holder. The connector holders are arranged to sort out the connectors for the respective groups of the branch wires based on an operation procedure at the main line.

Accordingly, the connectors can be sorted into a plurality of groups for the respective branch wires based on the operation procedure at the main line, and the connectors are arranged to conform to the respective groups. Thus, the final modes of the respective branch wire portions can be maintained by the layout of the connectors. As a result, a relatively large subassembly (having, for example, 100 circuits and 26 connectors) can be produced easily in such a state where the respective wires are unlikely to get entangled. Further, this way of producing the subassembly makes a so-called previous insertion rate (rate of the number of inserted terminals to the total number of terminals) maximally approximate equal to 100%.

Further, it is not necessary to arrange the respective wires in their final modes. Since the modes of the respective branch wire portions can be maintained only by connecting the respective wires with the connectors, the wire laying step repeated in the conventional methods can be eliminated, thereby making the overall production process of the wiring harness significantly more efficient.

The invention enables the subassembly to be held in its layout mode in a compressed state by sorting the respective connectors for the respective branch wires and arranging them. Thus, even in the case of a large subassembly, a connecting operation and other operations for the subassembly can be performed in a compact work area by arranging the connectors in a concentrated manner. Therefore, operability can be improved in this respect as well.

In the above-described subassembly producing apparatus, it is preferable to further provide a temporarily holding device or subassembly device that can be mounted on the board and adapted to temporarily hold the respective wires connected with the connectors with the wires remaining sorted for the respective groups of the branch wires.

Such a temporarily holding or subassembly device enables the respective connectors (connector holders) to be arranged in a more concentrated manner by making the board smaller and a succeeding operation step for the subassembly can be easier since the wires connected with the respective connectors can be bundled by the temporarily holding device.

In the subassembly producing apparatus, the temporarily holding or subassembly device is preferably detachable so that the produced subassembly can be detached from the board while being held and/or transferred from the board of the subassembly line to the wire laying board of the main line.

Such an arrangement also makes taping of the respective wires least necessary because the produced subassembly can be conveyed to a main line while being temporarily held by the temporarily holding device.

In a specific mode, the subassembly is preferably a module having the same number of circuits as the final mode. In such a case, no wire connecting step is performed at the main line and operations performed there are limited to taping and mounting of external parts. If it is necessary to connect subassemblies, it is done by the connectors and no operation is necessary at a later stage to insert free terminals.

It is preferable to conduct an electrical connection test in the wire connecting step every time opposed ends of a terminal-mounted wire are connected. With such an arrangement, a connection error of the connected terminal-mounted wire can be detected quickly, thereby preventing a product that has a connection error from being transferred onto a later operation step.

Preferably, the wire connecting step is performed for optional small-size circuits which are selected in accordance with the type of the subassembly to be produced. With such an arrangement, a plurality of types of subassemblies can be produced by stocking optional small-size circuits beforehand at a station for option and connecting the terminal-mounted wires with the small-size circuits if necessary when producing wiring harnesses of products (e.g. automotive vehicle) having different grades.

These and other objects, features and advantages of the present invention will become apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a schematic plan view showing a portion of a subassembly producing apparatus according to one embodiment of the invention.

FIG. 2 is a perspective view of a push carriage carrying a board unit according to the embodiment of FIG. 1.

FIG. 3 is a perspective view showing a mounting structure for a transferring device of FIG. 2.

FIG. 4 is a perspective view showing the schematic construction of the subassembly transferring device according to the embodiment.

FIGS. 5(A) and 5(B) are front views of the transferring device without and with a rail, respectively.

FIG. 6 is a perspective view showing an operation of the transferring device.

FIG. 7 is a perspective view showing a portion of the transferring device according to the embodiment.

FIGS. 8(A) and 8(B) are schematic plan views showing a temporarily held state of the subassembly according to the embodiment before and after temporary holding, respectively.

FIGS. 9(A) and 9(B) are side views of a wire laying board adopted for a main line during and after wire arrangement, respectively.

FIGS. 10 to 15 are perspective views showing a transferring step.

FIG. 16 is an exploded perspective view showing an essential construction of a subassembly transferring device according to another embodiment of the present invention.

FIG. 17 is a partly broken schematic section showing an entire construction of the subassembly transferring device of FIG. 16.

FIG. 18A is a perspective view showing a used mode (standard specifications) of the subassembly transferring device of FIG. 16, and FIG. 18B is a perspective view showing a used mode (modified specifications) of the subassembly transferring device of FIG. 16.

FIG. 19A shows a further preferred embodiment of a subassembly device 500, and FIG. 19B and C show details of a clamping device or temporarily holding means 510 according to this embodiment.

FIG. 20 is a perspective view showing a production line of a wiring harness according to one embodiment of the invention.

FIG. 21 is a perspective view schematically showing the construction of an elevating carriage conveying apparatus according to the embodiment of FIG. 20.

FIG. 22 is a perspective view of a push carriage used in the elevating carriage conveying apparatus according to the embodiment of FIG. 20.

FIG. 23 is a perspective view enlargedly showing a portion of a terminal insertion assisting unit.

FIG. 24 is a schematic section enlargedly showing a portion of the terminal insertion assisting unit.

FIG. 25 is a section of a probe.

FIG. 26 is a block diagram of a connection assisting unit provided in the board unit.

FIG. 27 is a perspective view of a stocking table according to the embodiment of FIG. 20.

FIG. 28 is a block diagram of a wire connection instructing apparatus according to the embodiment of FIG. 20.

FIG. 29 is a schematic partial plan view of a subassembly line according to the embodiment.

FIGS. 30 to 33 are a flow chart showing a detailed connecting operation according to a preferred embodiment of the invention.

### DETAILED DESCRIPTION OF THE PREFERRED EMBODIMENTS

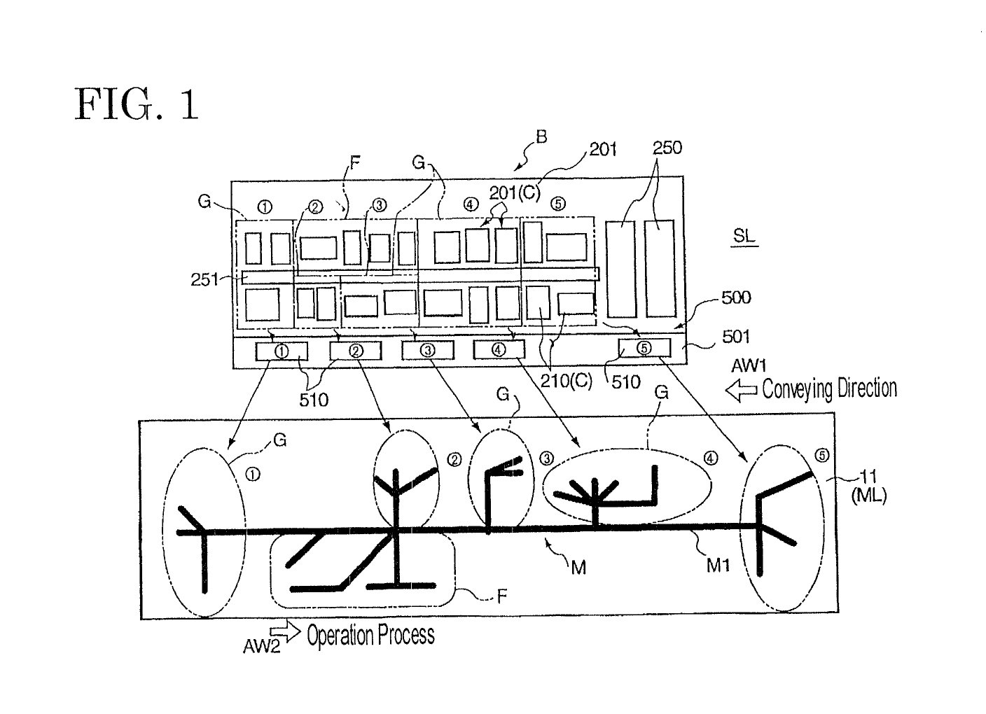

A production line in accordance with the invention is illustrated schematically in FIG. 1, and includes several subassembly lines SL for producing subassemblies and a main line ML for processing the subassemblies into a wiring harness. The subassembly lines SL are connected with the main line ML in a branched manner. The wiring harness produced by the main line ML may be a final wiring harness. Alternatively, a plurality of subassemblies from subassembly lines SL may be combined, mounted or pre-assembled in view of further processing in a final mounting line.

The main line ML comprises a plurality of wire laying boards 11 each of which is configured for laying a wiring harness thereon. A known conveyor conveys the wire laying boards 11 to each of a plurality of stations. Subassemblies M produced on the subassembly lines SL are gross assembled on the respective wire laying boards 11 of the main line ML to form a final or mounted wiring harness. The gross assembling includes the mounting of external parts, such as grommets and corrugated tubes, on the wiring harness.

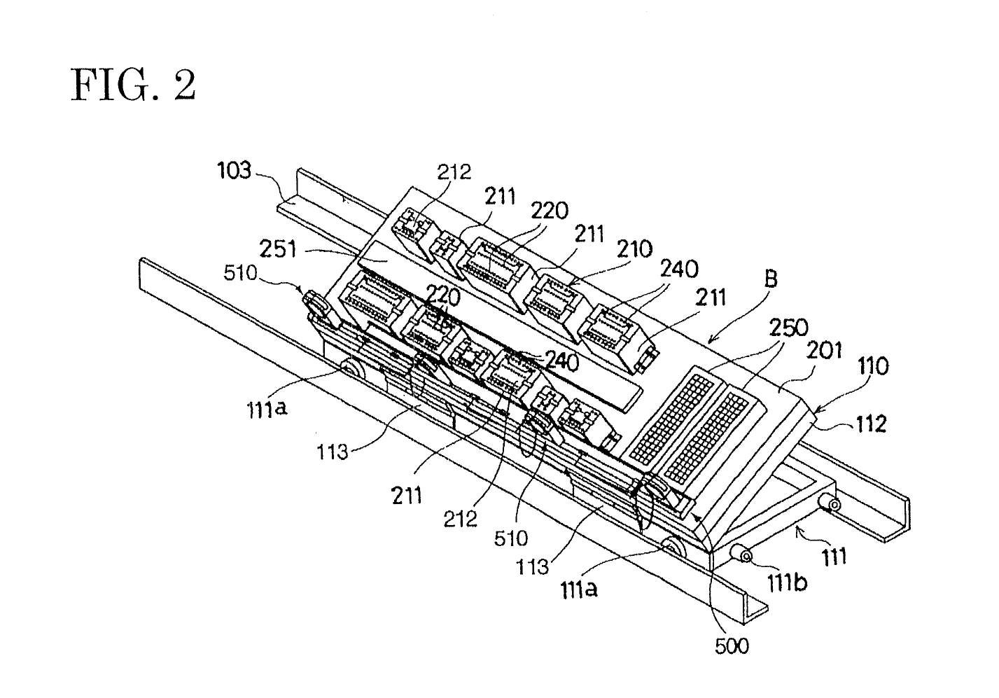

The subassembly line SL includes push carriages 110 that circulate on a conveyor used to produce a subassembly. The respective push carriages 110 carry board units B. Each push carriage 110 comprises a base 111 connected to a board frame 112 via hinges 113, as shown in FIG. 2. The board frame 112 carries a board 201 and runs on rails 103 by means of rollers 111a mounted on the base 111. Elastic stoppers 111b are provided on each base 111 to dampen the stops at the respective workstations. Connection operations for a subassembly M are performed by circulating the push carriage 110 from one station to another along the rails 103 and using terminal insertion assisting units 210 provided on the board 201.

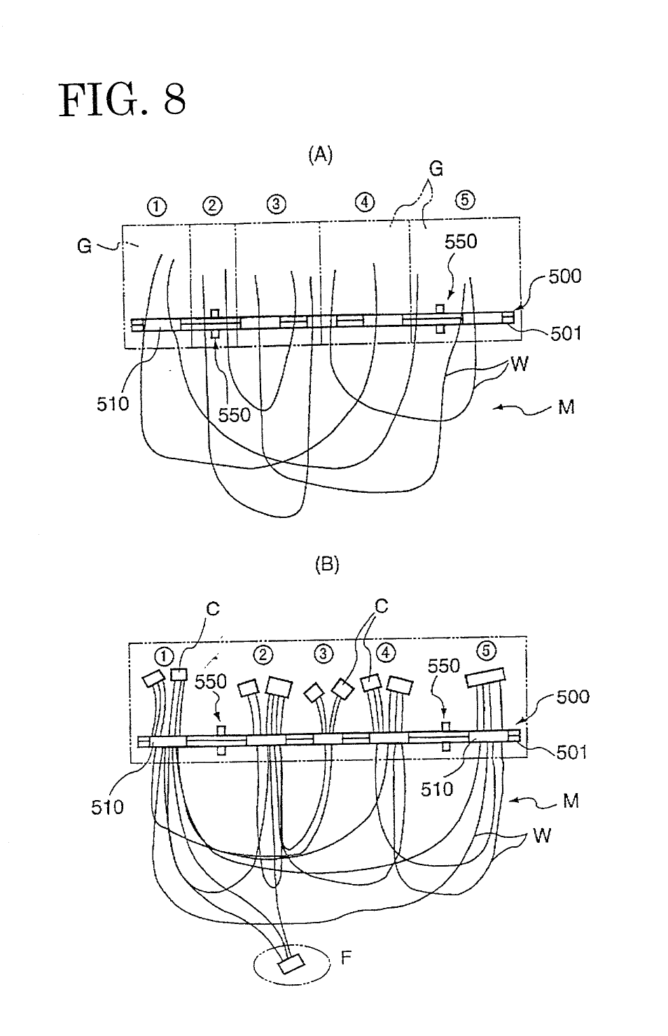

A bottomed connector accommodating portion 212 is open in the upper surface of the connector holder 211, and conforms with the outer configuration of a connector C. The connector holders 211 take various shapes to correspond to the number of contacts and the shapes of the connectors C that are to be held. The connector holders 211 are arranged so that the respective terminal accommodating portions 212 thereof can accommodate each of a plurality of the connectors C. Each of the held connectors C will receive one end of at least one terminal-mounted wire W. The other end of the terminal-mounted wire W will be connected with a connector mounted in another connector holder 211, as shown in FIG. 8.

A probe holding plate can be fixed at the bottom of the connector accommodating portion 212 of each connector holder 211, and probes 220 are held by the probe holding plate. The probes 220 preferably are provided in one-to-one correspondence with the contacts of the connector held by each connector holder 211. Thus, the respective probes 220 enter cavities of the connector C when the connector C is accommodated in the connector accommodating portion 212 and can be connected with the terminals of the terminal-mounted wires W that are inserted into the cavities.

Each terminal insertion-assisting unit 210 has an interface connector 250 and is connected electrically with a wire connection-instructing device (not shown) at the respective station. Display lamps 240 on the connector holder 211 are connected to the connection-instructing device and make necessary connection instructions for the subassembly M.

As shown in FIG. 1, the terminal insertion assisting units 210 are on the board 201 of the board unit B, and are sorted into groups G that correspond to the respective branch wires in a layout of the subassembly M when the subassembly M is arranged on the wire laying board 11 of the main line ML. The groups G are based on an operation procedure at the time of gross assembling.

As shown in FIG. 1, the wire laying board 11 of the main line ML may be moved, for example, in a conveying direction indicated by an arrow AW1. An operator then can efficiently conduct individual operations while standing substantially at a fixed position if he conducts operations in a direction AW2 opposite from the conveying direction AW1 of the wire laying board 11 of the main line ML. Accordingly, in the illustrated example, a work area of the operator on the wire laying board 11 of the main line ML is divided for the respective branch wires from an upstream side of the conveying direction AW1, and the terminal insertion assisting units 210 corresponding to the connectors of the corresponding groups G are arrayed from the left side to the right side of FIG. 1. The groups G are distinguished e.g. by coloring the respective terminal insertion assisting units 210 in different colors and/or inscribing partitioning lines on the board 201 for the respective groups G.

The terminal insertion assisting units 210 that are to be handled differently at a later stage, such as those corresponding to connectors for connecting wiring harnesses, are sorted as another group F in FIG. 1.

Final modes of the subassemblies M can be made smaller by sorting and arraying the respective connectors C for the respective branch wires. Thus, even in the case of producing a large subassembly M, connecting operations for the subassembly M can be performed within a small work area by arraying the connectors C in a concentrated manner. Therefore, operability can be improved.

The board unit B has a transferring device or temporary holding device 500, as shown in FIGS. 2, 3 and 8, for transferring and/or temporarily holding wires W for each group G. The transferring device 500 comprises a rail 501 and a plurality of retainers, such as elastic clamps or retainer jigs 510 on the rail 501. The elastic clamps 510 are provided on the rail 501 substantially in correspondence with the groups G allotted to the board unit B.

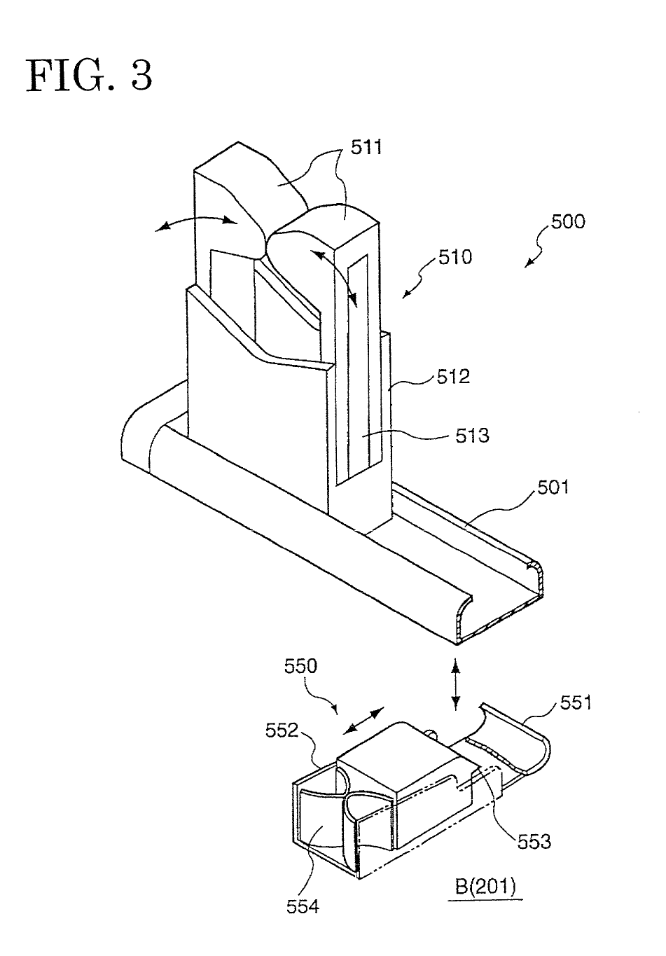

Each elastic clamp 510 has a pair of clamping pieces 511 mounted in a casing 512, as shown in FIG. 3, such that the clamping pieces can open and close with respect to each other. An elastic piece 513 is provided for each clamping piece 511 to bias the clamping pieces 511 toward each other, as shown in FIG. 3. The wires W can be held temporarily by the elastic clamps 510 after completing an operation of connecting the wires W with the connectors C. Thus, taping is unnecessary.

The transferring device 500 is mounted detachably on the board unit B by a detachable holder 550, as shown in FIG. 3. The detachable holder 550 includes a bracket 552 with a locking claw 551 and a slidable claw 553. The slidable claw 553 slides between a holding position for tightly holding the transferring device 500 in cooperation with the locking claw 551 and a releasing position for releasing the transferring device 500. An X-shaped leaf spring 554 biases the slidable claw 553 toward the holding position. Several brackets 552 are provided in suitable positions on the board unit B, so that the transferring device 500 can be attached and detached.

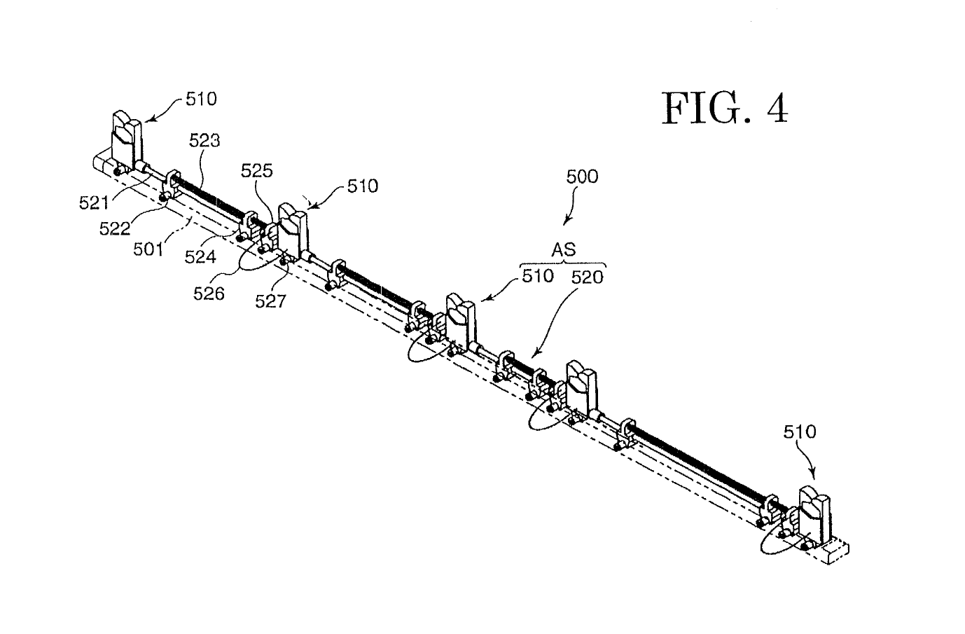

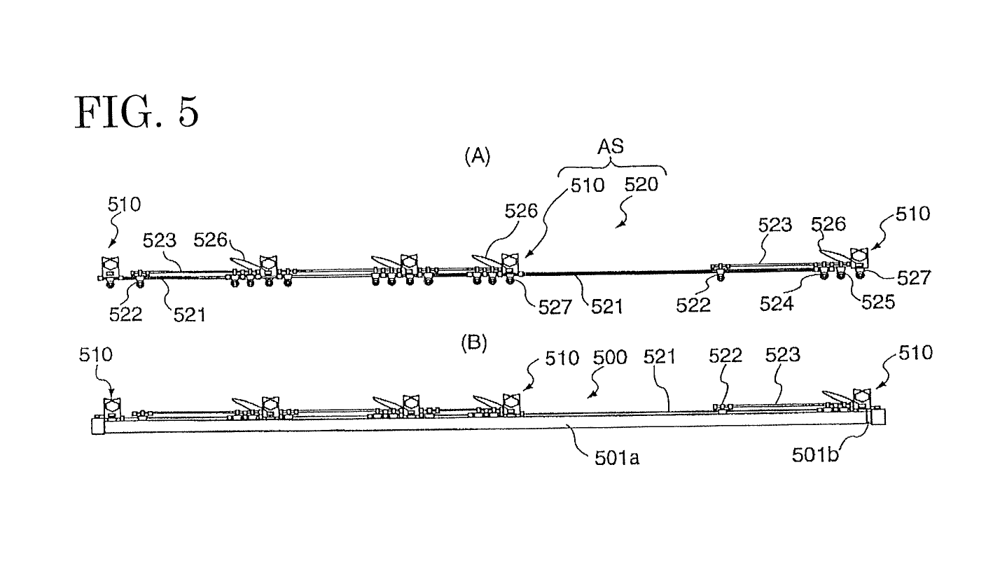

Each coupling mechanism 520 has a rod 521, as shown in FIGS. 4 to 6. The rods 521 extend substantially parallel to the rail 501 and have one end fixed at one side of the corresponding elastic clamp 510. A slider 522 is mounted for reciprocation on or in the rod 521 and a rigid wire 523 extends from the slider 522 substantially parallel to the rod 521. A stopper slider 524 is fixed to an end of the rod 521 and reciprocates along the rigid wire 523, and a coupling slider 525 is fixed to an end of the rigid wire 523. The coupling slider 525 is guided along the rail 501 in a reciprocating manner. A wire 526 couples the coupling slider 525 to a next elastic clamp 510 that faces or is adjacent to the coupling slider 525. The aforementioned pattern is preferably repeated.

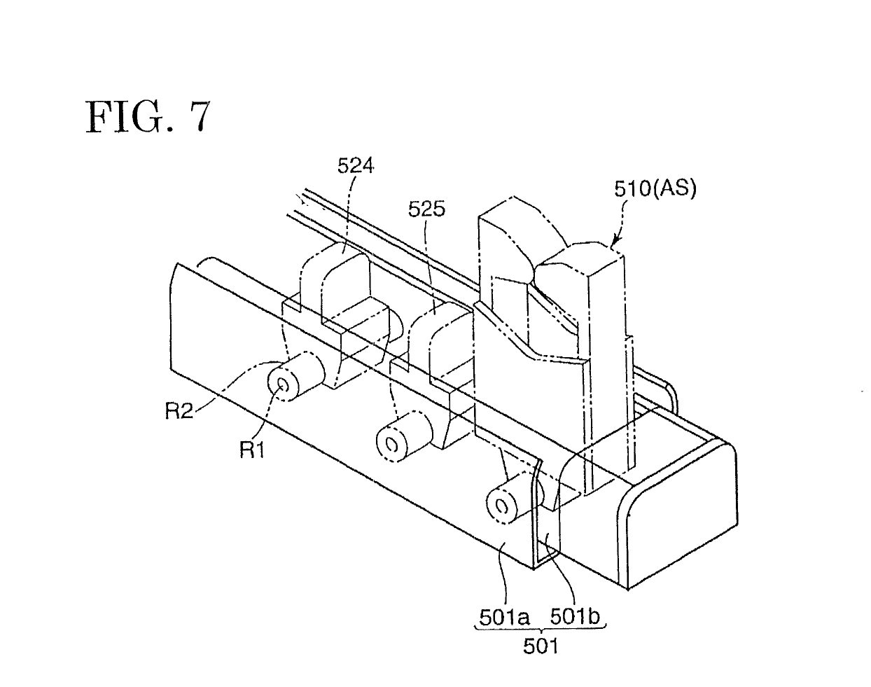

The sliders 522, 524, 525 preferably are formed of the same type of slidable members that can reciprocate along the rail 501, and may be the slide runners of a curtain rail. In the illustrated example, the sliders 522, 524, 525 reciprocate by mounting sleeves R2 on cores R1 for rotation and causing the sleeves R2 to rotate in the rail 501 as shown in FIG. 7. A slider 527 of the same type is provided below the elastic clamp 510 in the shown example.

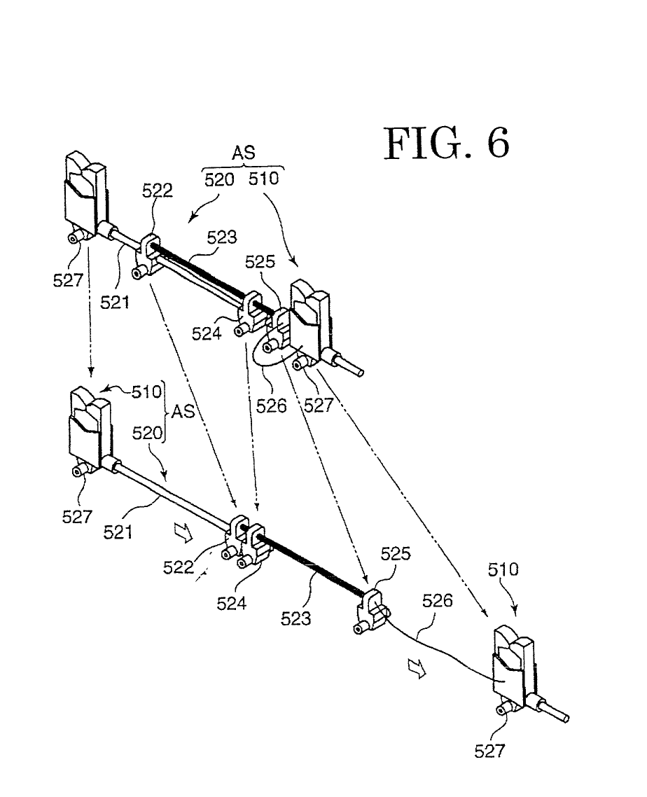

The slider 522 of FIG. 6 can be displaced along the rod 521 between the elastic clamp 510 at one end of the rod 521 and the stopper slider 524 at the opposed end of the rod 521. Thus, the slider 522 can transmit a force of displacement to the elastic clamp 510 by contacting the elastic clamp 510 or the stopper slider 524. The coupling slider 525 is connected to the slider 522 by the rigid wire 523 and is coupled to a second elastic clamp 510 by the wire 526. Thus, if the second elastic clamp 510 is moved away from the first elastic clamp 510, the wire 526 generates movement of the coupling slider 525, the rigid wire material 523, the slider 522 the stopper slider 524 and the first elastic clamp 510. Thus, the flexible wire 526 provides a simple construction to link the movements of the two elastic clamps 510 while permitting a relative displacement thereof.

The rail 501 is comprised of a channel-shaped outer rail 501a and an inner rail 501b that is telescoped into the outer rail 501a, as shown in FIGS. 1 and 7. An assembly AS of the elastic clamps 510 and the coupling mechanisms 520 is accommodated in the rails 501a, 501b, and the sliders 527 of the elastic clamps 510 that correspond to the opposite ends of the assembly AS are secured to the ends of the corresponding rails 501a, 501b. Thus, the two rails 501a, 501b can be displaced relative to one another, but have their separation restricted by the specified maximum extended length of the assembly AS. With this construction, the rail 501 can be mounted on the board 201 of the board unit B in a compressed state with the inner rail 501b accommodated in the outer rail 501a, as shown in FIGS. 1 and 2. Thus, the subassembly M can be held temporarily on the board 201, as shown in FIGS. 8(A) and 8(B). The subassembly M that is held temporarily by the transferring device 500 can be extended to the width of the wire laying board 11 and can be arranged on the wire laying board 11 in the extended condition after the transferring device 500 is detached from the board 201. The subassembly M then can be arranged on the wire laying board 11 of the main line ML as described next.

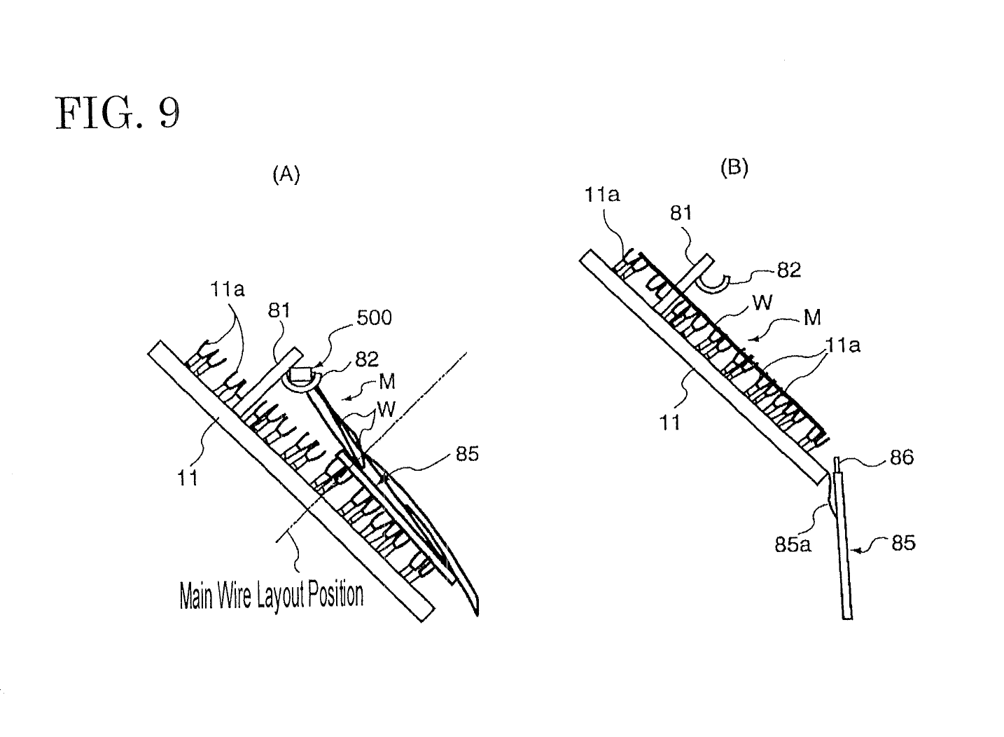

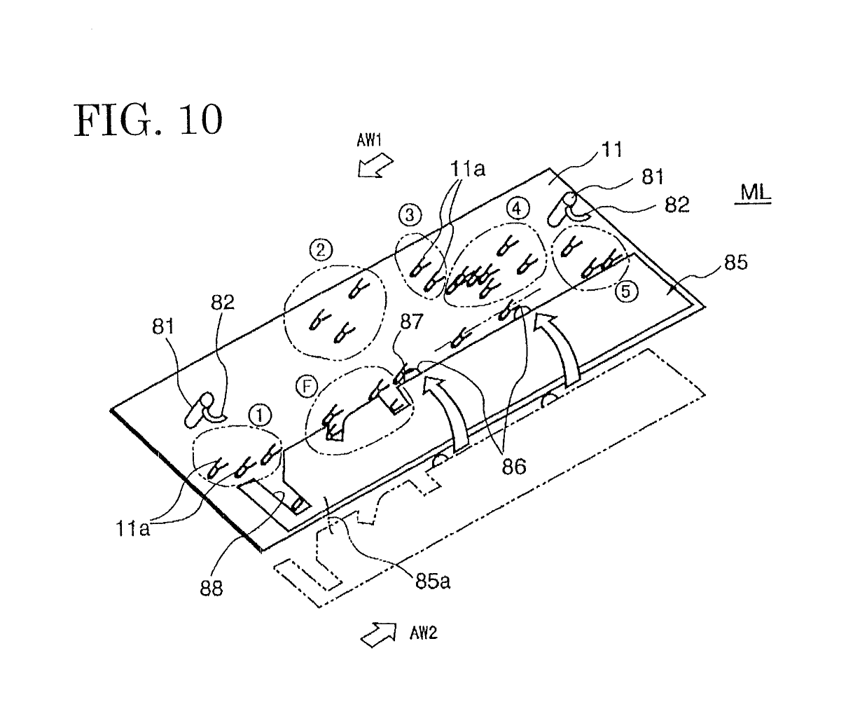

Next, a transfer process of the subassembly M on the main line ML is described with reference to FIGS. 9 to 15. First, with reference to FIGS. 9(A), 9(B) and 10, the wire laying board 11 is a plate member inclinable toward an operator, as is known in the art. Wire holders 11a are arranged in a predetermined order on the wire laying board 11, and are configured for carrying portions of the subassembly M. Thus, the subassembly M can be arranged in a final mode by being laid in accordance with the array of the wire holders 11a.

The subassembly M of the embodiment shown in FIG. 1 is a branched subassembly, and has groups of branch wires (1) to (5) that extend from a main wire. The respective wire holders 11a of the wire laying board 11 are arranged in this branched pattern.

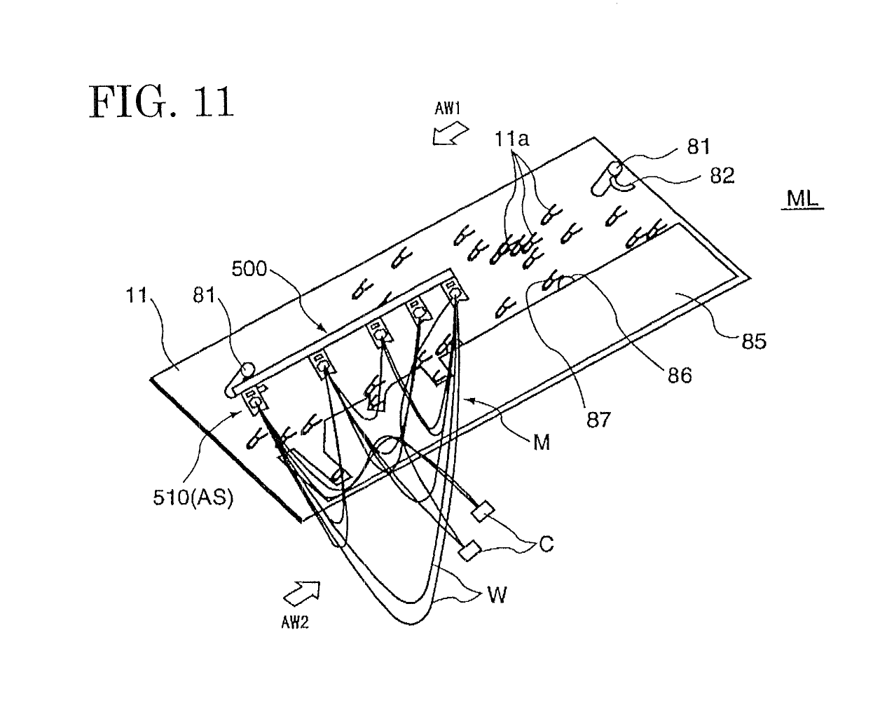

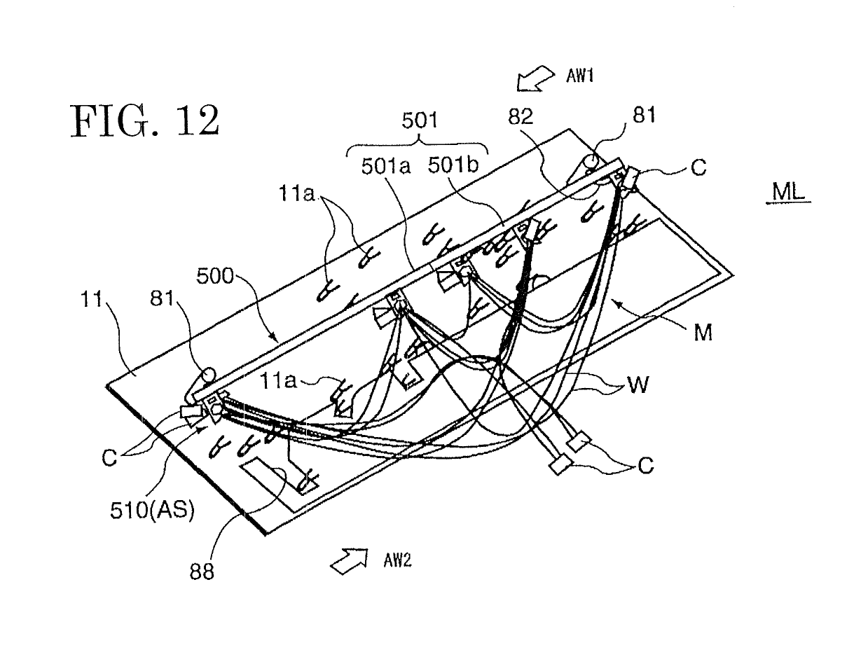

Pillars 81 stand at positions above a main wire layout position where the main wire M1 is laid, as shown by phantom line in FIG. 9(A). Top ends of the pillars 81 are formed with hooks 82 that are configured to hold the transferring device 500 on the wire laying board 11, as shown in FIGS. 11 and 12. A cover 85 can be mounted on each wire laying board 11 by wires 85a or hinges, as shown in FIGS. 10 and 11. The cover 85 prevents inadvertent engagement between the holders 11a and the subassembly M that hangs from the transferring device 500 suspended from the hooks 82. More particularly, the cover board 85 substantially covers top parts of the wire holders 11a located below the main wire layout position (see FIG. 9(A)), so that the subassembly M can hang down on the cover board 85 without entangling the wires W.

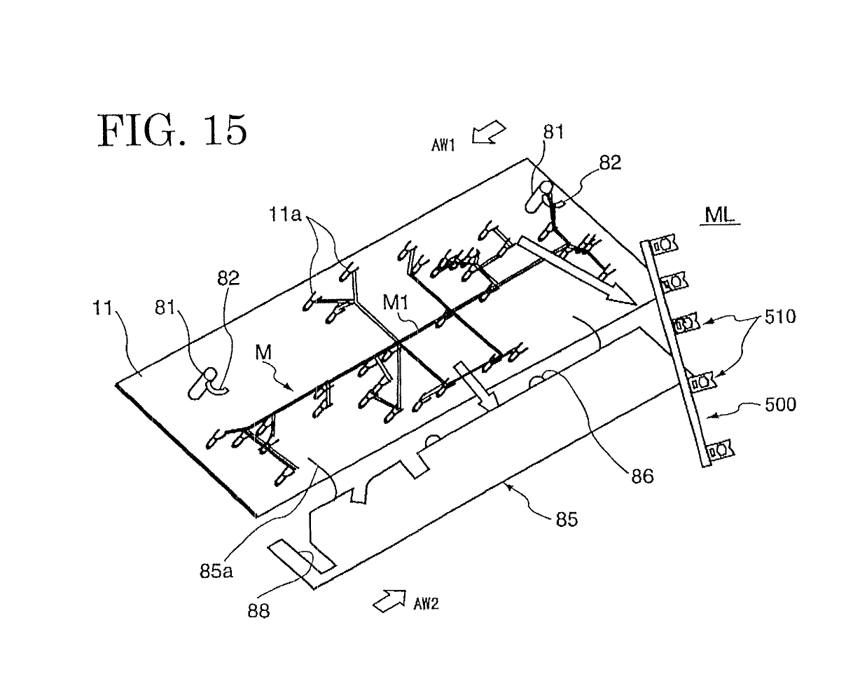

The cover board 85 is configured to cover only certain wire holders 11a. Additionally, the wires 85a enable the cover board 85 to be displaced between a covering position where the certain wire holders 11a are covered, as shown in FIGS. 10 to 14, and an exposing position where all the wire holders 11a are exposed, as shown in FIG. 15.

The cover board 85 preferably is formed from urethane or other relatively lightweight material that can be processed easily. Thus, the cover board 85 can be handled easily handled and processed easily into a desired shape.

Hooks 86 are provided at the upper edge of the cover board 85, and can be engaged with specified holders 87 to hold the covering board 85 in the covering position on the wire laying board 11. The holders 87 are identical to the holders 11a in the illustrated embodiment. However, the holders 87 may be specially configured hooks.

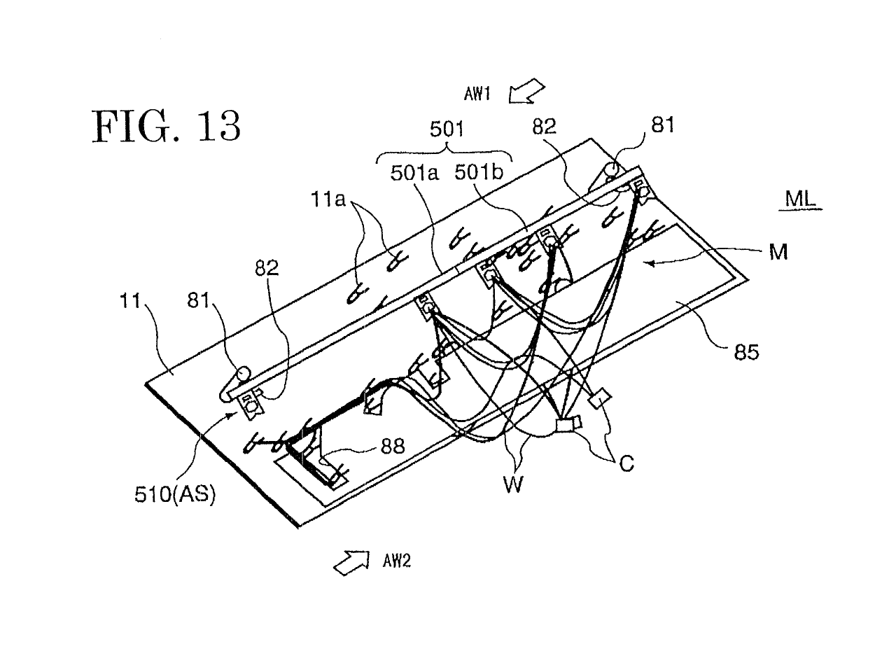

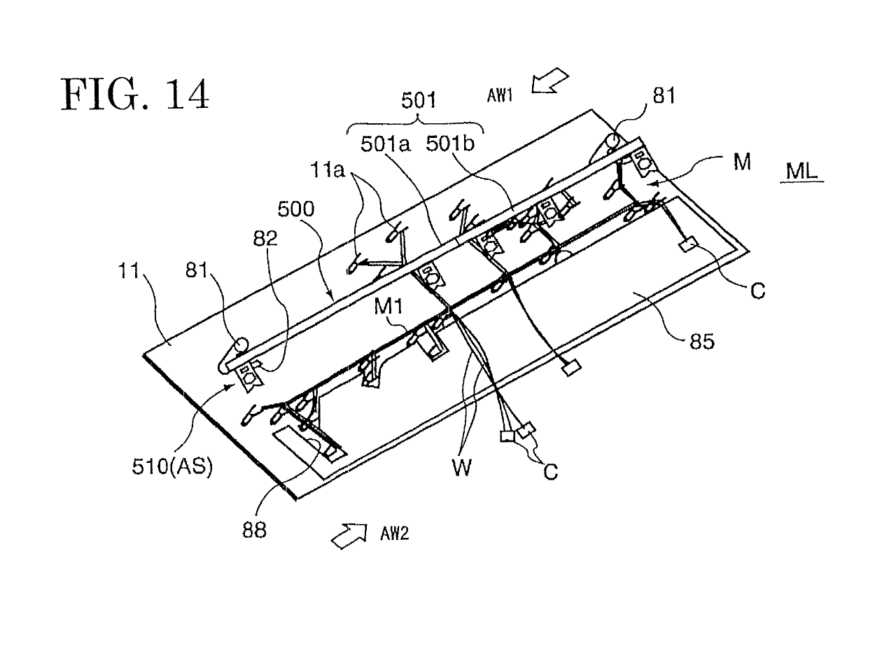

A notch 88 is formed in a position on the cover board 85 to expose certain wire holders 11a below the main wire layout position. The notch 88 allows the subassembly to be arranged on specific holders 11a below the transferring device 500 on the wire laying board 11 (see e.g. FIGS. 13 and 14). Thus, the operator can efficiently perform a transferring operation along the direction AW2 opposite from the conveying direction AW1 of the wire laying board 11 of the main line ML, as described below.

The hooks 86 of the cover board 85 are engaged with the holders 87 on the wire laying board 11 to fix the cover board 85 in a specified position on the wire laying board 11, as shown in FIG. 10. Subsequently, the transferring device 500 that temporarily holds the subassembly M can be placed in the hooks 82 on the pillars 81 on the wire laying board 11, as shown in FIG. 11. The transferring device 500 is contracted to conform to the length of the board unit B at this stage. Hence, an end of the transferring device 500 preferably is placed first in the pillar 81 at the downstream side with respect to the conveying direction AW1 of the wire laying board 11.

The rail 501 of the transferring device 500 then is extended and the other end of the transferring device 500 is placed in the hook 82 on the pillar 81 at the upstream side with respect to the conveying direction AW1 of the wire laying board 11, as shown in FIG. 12. The rail 501 can be extended easily with the elastic clamp 510 fixed to the corresponding end of the transferring device 500 locked in the downstream hook 82. Thus, the subassembly M is extended from the compressed state while maintaining the layout mode sorted and grouped for the respective branch wires.

Thereafter, as shown in FIGS. 13 and 14, The branch wires then are detached successively from the elastic clamps 510 of the transferring device 500 and are placed in the wire holders 11a from the downstream side of the conveying direction AW1 of the wire laying board 11, as shown in FIGS. 13 and 14. Thus, the subassembly M can be arranged easily on the wire laying board 11. This wire arranging operation is performed while the subassembly M is hanging down on the cover board 85. Therefore, the wires W of the subassembly M will not be caught by the holders 11a. Furthermore, the notch 88 is formed in the specified position on the cover board 85 and the wires W can be arranged on the holders 11a exposed through the notch 88 in the illustrated embodiment. Consequently, the wire arranging operation can be performed smoothly and successively in one direction from the downstream side with respect to the conveying direction AW1 of the wire laying board 11, and excess back and forth movements by the operator can be avoided.

After the wires of the groups G not covered by the cover board 85 are completely arranged, the cover board 85 is brought down from the wire laying board 11 to arrange the wires W of the groups G below the main wire M1 as shown in FIGS. 9(B) and 15. The transferring device 500 may be detached after completion of all wire arranging operations.

The above-described invention enables the subassembly M to be produced in a compressed layout mode and then extended on the wire laying board 11 of the main line ML. These features of the invention substantially reduce the size of the work area and improve efficiency of the subassembly producing operation. Furthermore, the compressed subassembly M can be transferred smoothly to the main line ML. Therefore, the above-described invention enables a large subassembly M to be produced easily and with a remarkably improved efficiency.

The subassembly arranging operation can be performed easily merely by providing the wire laying board 11 and the simply constructed cover board 85. Thus, operational efficiency can be improved significantly by a small cost of equipment.

The hooks 86 and the holders 87 shown in FIGS. 10 to 14 enable the cover board 85 to be handled easily and mounted easily on each wire laying board 11. As a result, a production line in which the wire laying boards 11 are conveyed by a conveyor can be converted easily into a main line ML that can accommodate the subassemblies M, as described above.

The aforementioned embodiment is merely an illustration of a preferred specific example of the present invention, and the present invention is not limited thereto. For example, the present invention is also applicable to a wire laying board that is not conveyed by a conveyor.

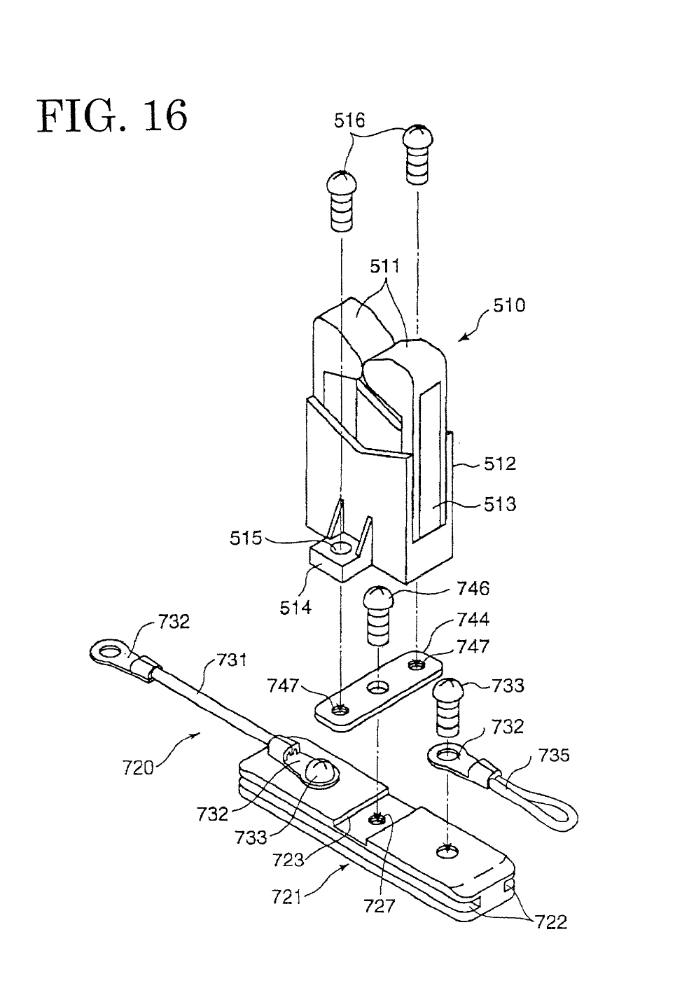

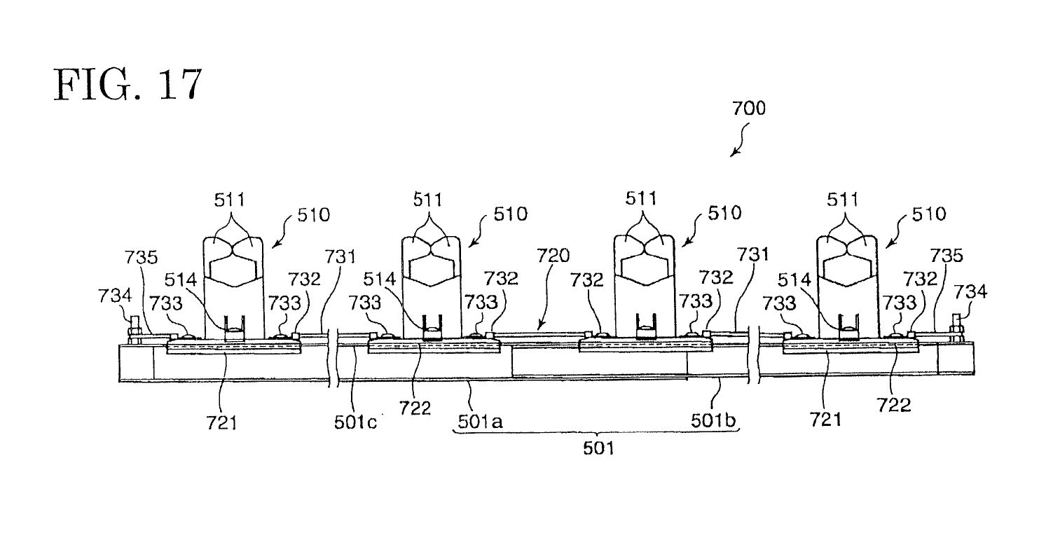

A second embodiment of a transferring device according to the present invention is illustrated in FIGS. 16 to 18. More particularly, FIGS. 16 and 17 show a coupling mechanism 720 that may be employed instead of the coupling mechanism 520 of FIGS. 4 and 7. The coupling mechanism 720 has slidable pieces 721 that slide in or move along the rail 501. The respective slidable pieces 721 are e.g. resin-molded parts that have identical specifications and a substantially rectangular parallelepiped shape. More particularly, the slidable piece 721 are formed at opposite sides with grooves or recesses 722 for receiving guiding edges or undercuts 501c of the outer and/or inner rails 501a, 501b of the rail 501. Thus, the respective slidable pieces 721 can reciprocate along the longitudinal direction of the rail 501 by slidably fitting the guiding edges 501c of the rail 501 in the grooves 722.

The respective slidable pieces 721 are coupled 501 by wires or linking members 731 similar to those of the embodiment of FIG. 4 and are relatively displaceable along the longitudinal direction of the rail 501. The respective wires 731 are flexible metallic wires having terminals or lugs or eyelets 732 secured to their opposite ends. The terminals 732 are fixed to the slidable pieces 721 by screws 733, as shown. Thus, the wires 731 couple the slidable pieces 721 for limited movement toward and away from each other. The respective terminals 732 are located within the planes of the slidable pieces 721 so that the slidable pieces 721 can abut against each other. Accordingly, the length of the wires 731 define or limit the maximum distance by which neighboring slidable pieces 721 can moved away from each other.

Location pins 734 project at one end of the outer rail 501a and the other end of the inner rail 501b, as shown in FIG. 17. An endless wire 735 is engaged with the corresponding location pin 734 and is fixed at an end of the slidable piece 721 located at the end of the respective rail 501a or 501b, as shown FIG. 16. The connection of the slidable pieces 721 with the location pins 734 links the movement of the slidable pieces 721 with the relative displacement of the outer and inner rails 501a, 501b of the rail 501, as in the embodiment shown in FIG. 4.

A mount groove or recess 723 extends widthwise across the middle of each slidable piece 721, and a mount plate 744 is secured symmetrically in the mount groove 723 by passing a screw 746 through an insertion hole in the middle of the mount plate 744 and engaging the screw 746 in a threaded hole 727 formed in the middle of the mount groove 723. The mount plate 744 also is formed with a pair of threaded holes 747 at its opposite longitudinal ends.

The elastic clamp 510 includes stays 514 integrally or unitarily formed with the casing 512 on its front and rear sides (only one stay is visible in FIG. 16). The elastic clamp 510 is detachably fixed to the slidable piece 721 via the mount plate 744 by inserting screws 516 through the insertion holes 515 in the stays 514 and engaging the screws 516 with internally threaded holes 747 of the mount plate 744. In the shown example, the head of the screw 746 does not interfere with the elastic clamp 510 because an unillustrated clearance is formed at the bottom of the elastic clamp 510.

In the embodiment shown in FIGS. 16 to 18, the elastic clamps 510 can be moved toward and away from each other as the rail 501 is extended and contracted, basically as in the embodiment of FIG. 4. Accordingly, the subassembly can be transferred to the main line while maintaining its final layout on the wire laying board.

Further, the slidable pieces 721 of the same specifications are mounted on the rail 501 and the elastic clamps 510 are detachably fixed to the respective slidable pieces 721. Accordingly, the transferring or temporarily holding device 700 may be used in the following mode.

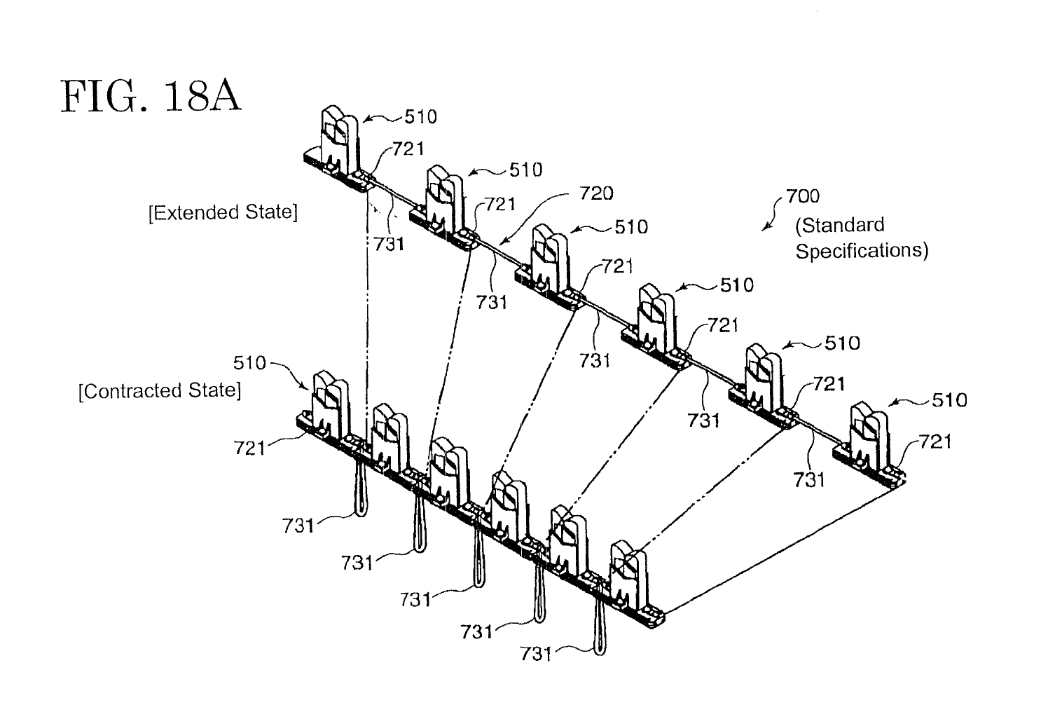

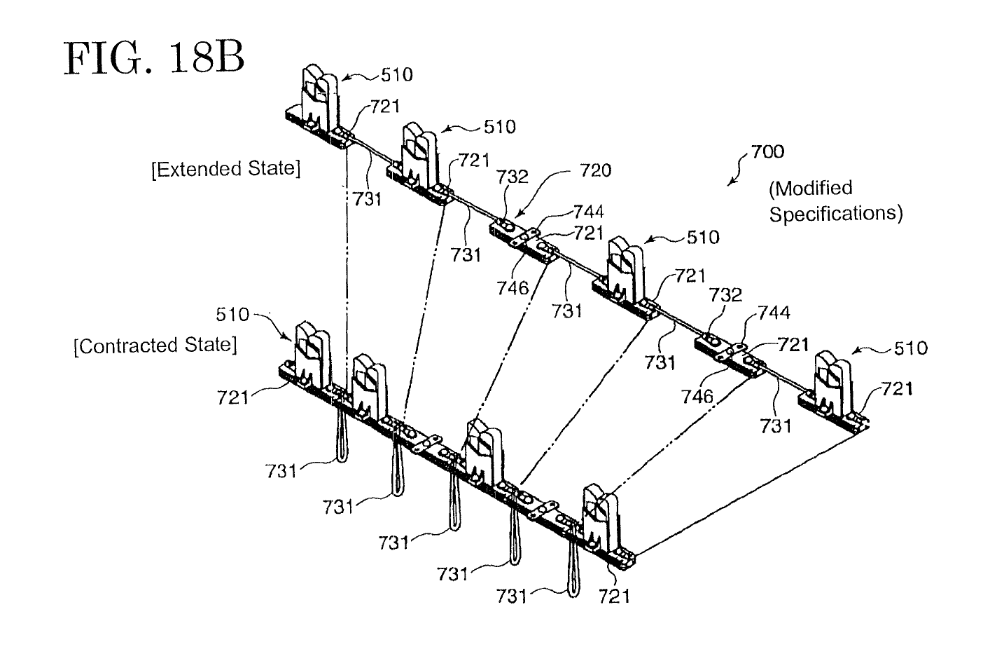

Several kinds of subassemblies can be produced by constructing the transferring device 700 so that the number of the slidable pieces 721 corresponds to a subassembly having a maximum number of wires and the elastic clamps 510 are fixed to all of the slidable pieces 721, as shown in FIG. 18A. With such a construction, the transferring device 700 of the standard specifications can be used as it is in the case of producing a subassembly having a maximum number of wires. A transferring device 700 of different specifications can be formed easily, as shown in FIG. 18B, merely by detaching unnecessary elastic clamps 510 from the transferring device 700 of the standard specifications to produce a subassembly having fewer wires.

The transferring device 700 can be provided with versatility in the embodiment shown in FIGS. 16 to 18. Therefore, it is not necessary to redesign the transferring device for each kind of subassembly to be produced. Thus, the transferring device 700 of this embodiment can be implemented easily and inexpensively in a line for producing subassemblies of various product numbers and a mixed production line in which lines of subassemblies of several product numbers are connected with the same production line.

Further, the elastic clamps 510 can be detached and attached to the slidable pieces 721. Hence, replacement can be made very easily even if the elastic clamp 510 is broken, and maintenance is improved.

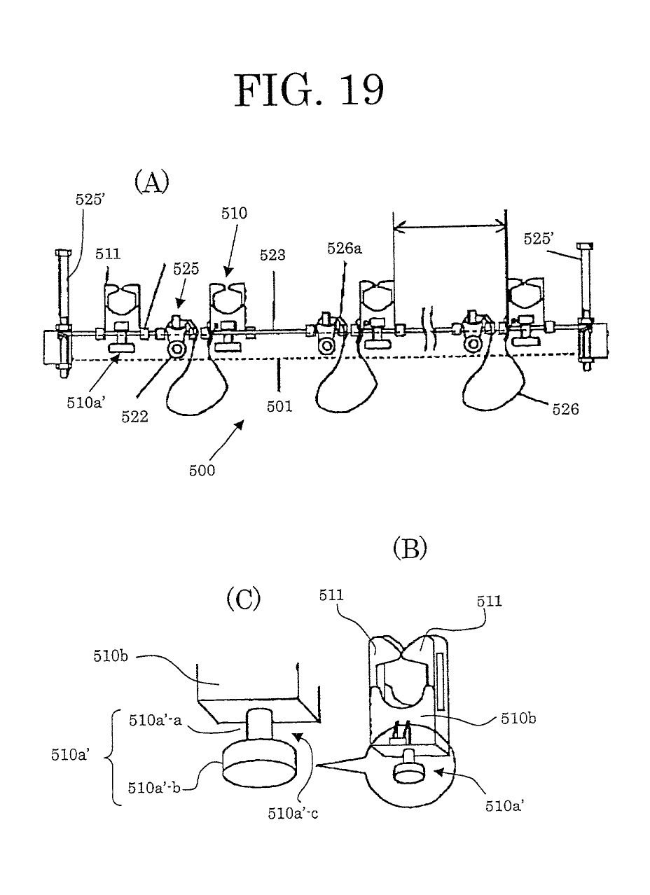

A further embodiment of a subassembly device 500 is shown in FIGS. 19 A-C. In this embodiment, the clamping device or temporarily holding means 510 comprises a base 510b and clamping pieces similar to the previous embodiment. However, the base 510b is mounted on a carrier or rail 501 by a fixing member 510a′ that has a mushroom-shape or T-shape cross-section. The fixing member 510a′ comprises a narrow portion 510a′-a and a wide portion 510a′-b projecting from an end of the narrow portion 510a′-a, thereby defining an undercut or recess 510a′-c that can cooperate with an undercut (not shown) of the carrier 501.

In this embodiment, adjacent clamping means 510 are coupled by coupling means 526 comprising rigid coupling means 523 (e.g. formed of rigid wire material) and deformable coupling or compressible coupling means 526 (such as a wire material 526). Location pins 525′ define the movable range of the clamping devices 510. The location pins 525′ can be at the ends (FIG. 19A) and/or at intermediate portions (not shown) of the carrier 501. Intermediate portions of the subassembly device 500 include movable coupling devices 525 for coupling two neighboring clamping devices 510. The coupling device 525 comprises one or more sliders 522, e.g. in the form of rollers.

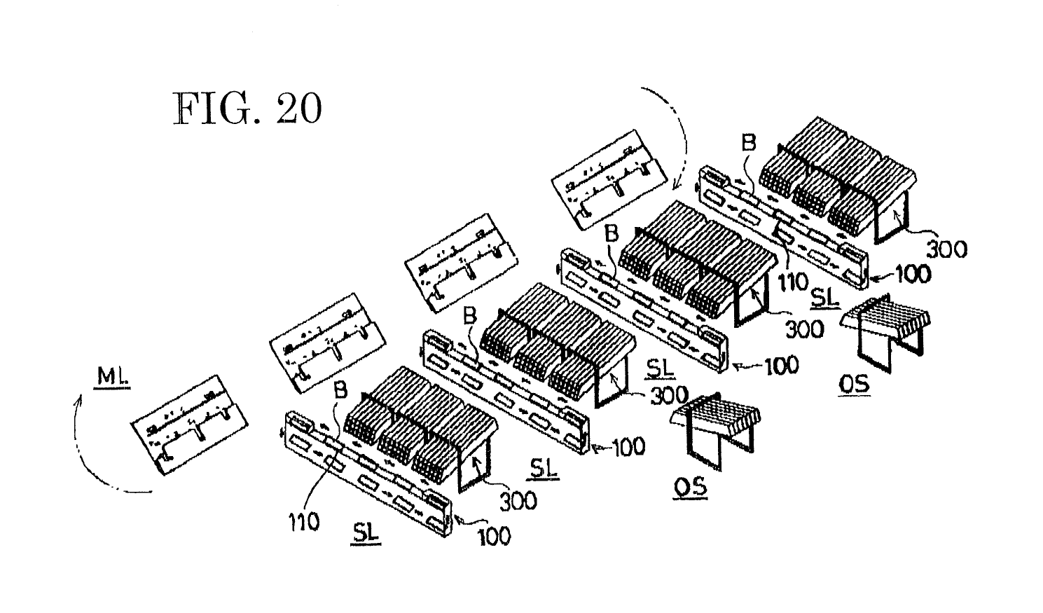

A further preferred embodiment of the invention is described in detail with reference to FIGS. 20 to 34. First, with reference to FIG. 20, the production line includes a main line ML for finishing a final wiring harness and a plurality of subassembly lines SL connected with the main line ML in a branched manner. Some of the subassembly lines SL are provided with an option station OS for stocking optional circuits.

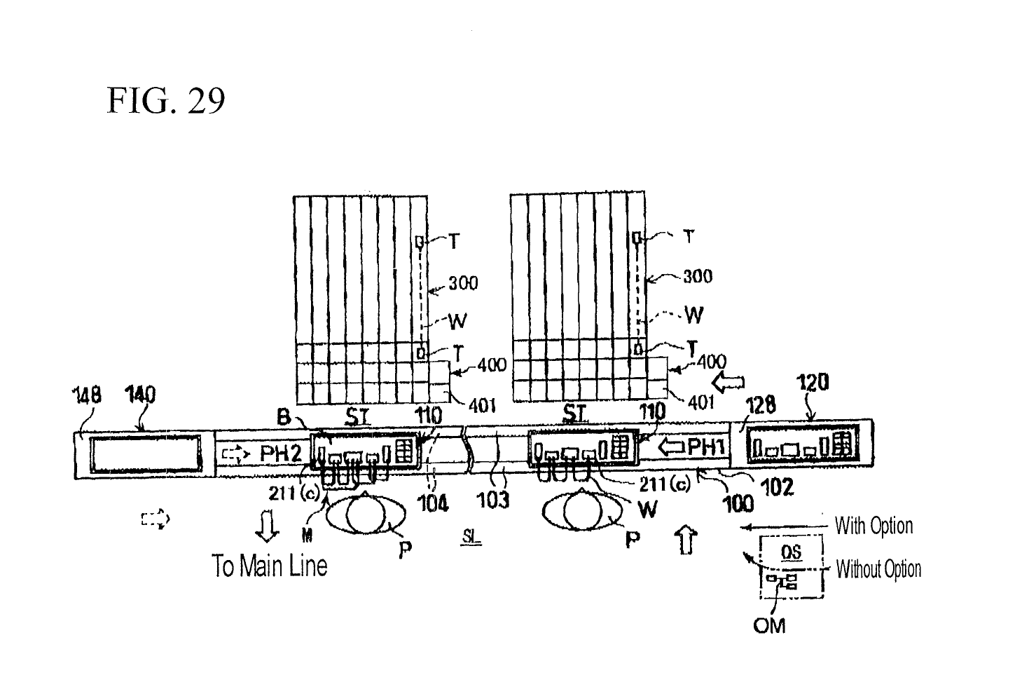

The main line ML has wire laying boards 11 that are conveyed by a known conveyor. Each wire laying board 11 is used for gross-assembling subassemblies M (see FIG. 29) that were produced on the subassembly lines SL to produce a final wiring harness or a wiring harness to be processed or assembled further. The wire laying boards 11 also are used for mounting external parts such as grommets and corrugated tubes on the wiring harness.

The subassembly line SL has an elevating carriage conveying apparatus 100 to produce a subassembly M, a board unit B to be conveyed by the elevating carriage conveying apparatus 100, and a wire supplying table 300 for stocking terminal-mounted wires W to be assembled into the subassembly M.

The elevating carriage conveying apparatus 100 is adapted to move carriers or push carriages 110 substantially linearly from one work station ST to another (see FIG. 29) along the subassembly line SL, so that specified processing can be applied in each work station ST. In the illustrated example, one wire supplying table 300 is provided for each work station ST, and the board unit B (see FIG. 2) is carried on each push carriage 110. A specified subassembly M is produced by inserting the terminal-mounted wires W into connectors C at the successive work stations ST.

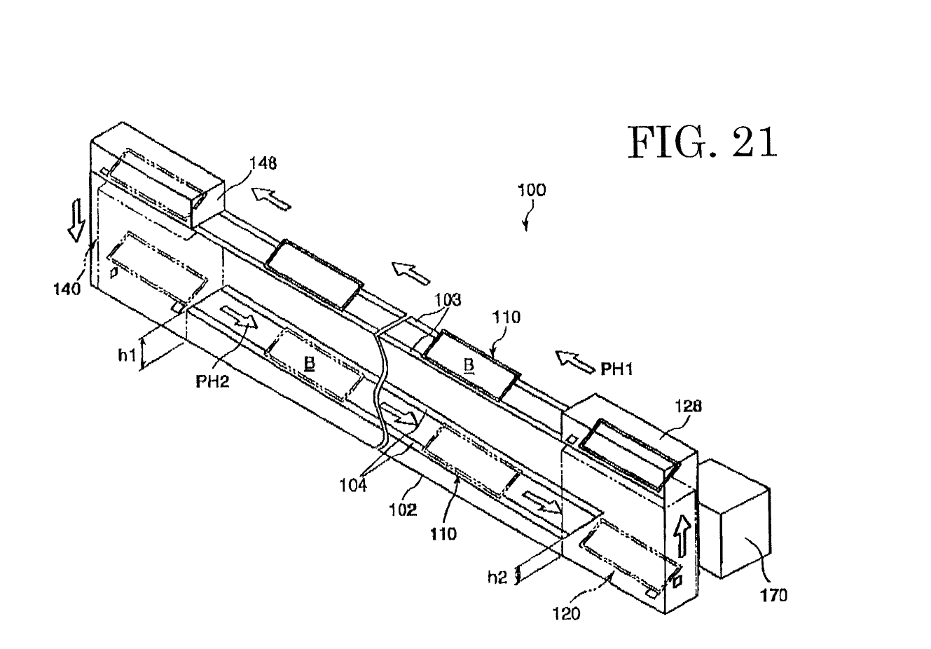

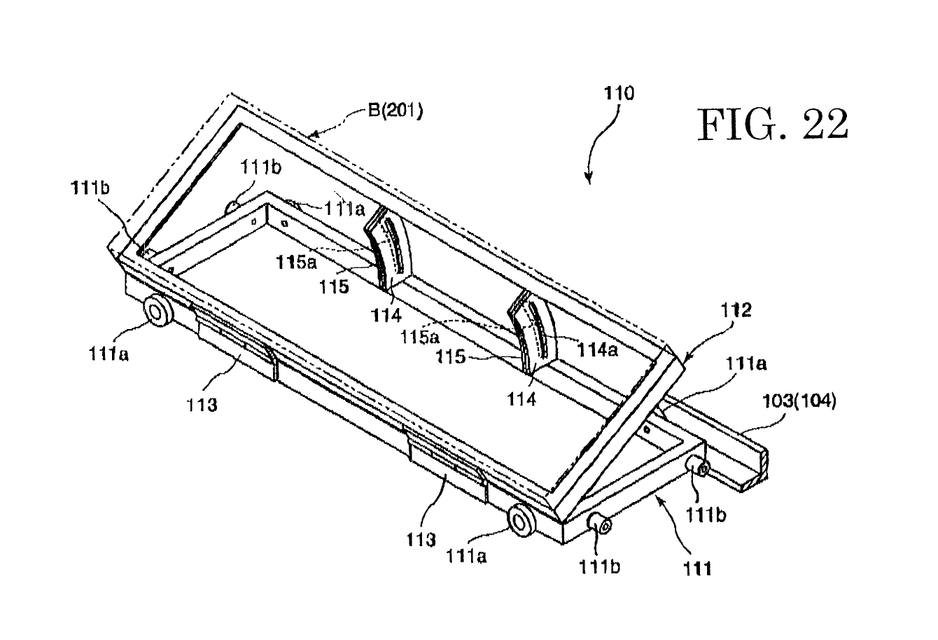

The elevating carriage conveying apparatus 100 is shown in FIG. 21 and has a frame 102 formed by welding a plurality of angles into a box shape. A forward path PH1 for moving the carriages 110 from one station ST to another is formed by rails 103 disposed on top of the frame 102, as shown in FIG. 22.

A return path PH2 is formed by rails 104 at the bottom of the frame 102. The return path PH2 is provided immediately below the forward path PH1 and is adapted to move push carriages 110 from a downstream end of the forward path PH1 to an upstream end of the forward path PH1. Opposite sides of the paths PH1, PH2 are provided with elevating or lowering conveyors 120, 140, which circulate the push carriages 110 from one path PH1 (PH2) to the other PH2 (PH1), thereby constructing an endless conveyor. The rails 104 of the return path PH2 preferably are inclined by setting a height h1 at the upstream end larger than a height h2 at the downstream end. Thus the push carriages 110 can return from the upstream end to the downstream end by the action of gravity, as described later. Safety covers 128, 148 cover the push carriages 110 at upper transfer positions, as shown in FIG. 21.

The push carriage 110 is constructed by connecting a base 111 and a board frame 112 via hinges or mounting means 113, as shown in FIG. 22. The board frame 112 carries a board 201 and runs on rails 103 by means of rollers 111a on the base 111. Connection operations for a subassembly M are performed by circulating the push carriage 110 from one station to another along the rails 103 and using terminal insertion assisting units 210 on the board 201.

The base 111 is formed e.g. by welding pipes into a structure substantially that is rectangular in plan view, and rollers 111a are mounted on the opposite longer sides (only one side is shown). The base 111 is horizontally movable by rolling the rollers 111a on the rails 103 (or rails 104). Further, rubber stoppers 111b are mounted on each of the shorter sides of the base 111.

The board frame 112 is adapted to hold the board unit B (shown only in phantom line in FIG. 22), and is assembled e.g. by welding angles to have substantially the same shape in plan view as the base 111. The board frame 112 and the base 111 are coupled along one side by hinges 113 so that the board frame 112 can be inclined toward an operator. Further, pairs of mounting plates 114, 115 are fixed or welded to cantilever from the other side of the base 111 and the board frame 112. The mounting plates 114 on the base 111 and the mounting plates 115 on the board frame 112 are provided in positions where they can be joined together. The respective mounting plates 114, 115 are formed with oblong holes 114a, 115a that extend along an arc centered on a center of rotation of the hinges 113. The board frame 112 and the base 111 can be assembled with the board frame 112 inclined by a specified angle by joining the mounting plates 114, 115 together by means of unillustrated bolts inserted through the oblong holes 114a, 115a and by nuts. In other words, an angle of inclination of the board frame 112 can be adjusted by changing a position of joining the mounting plates 114, 115 together along the extension of the oblong holes 114a, 115a.

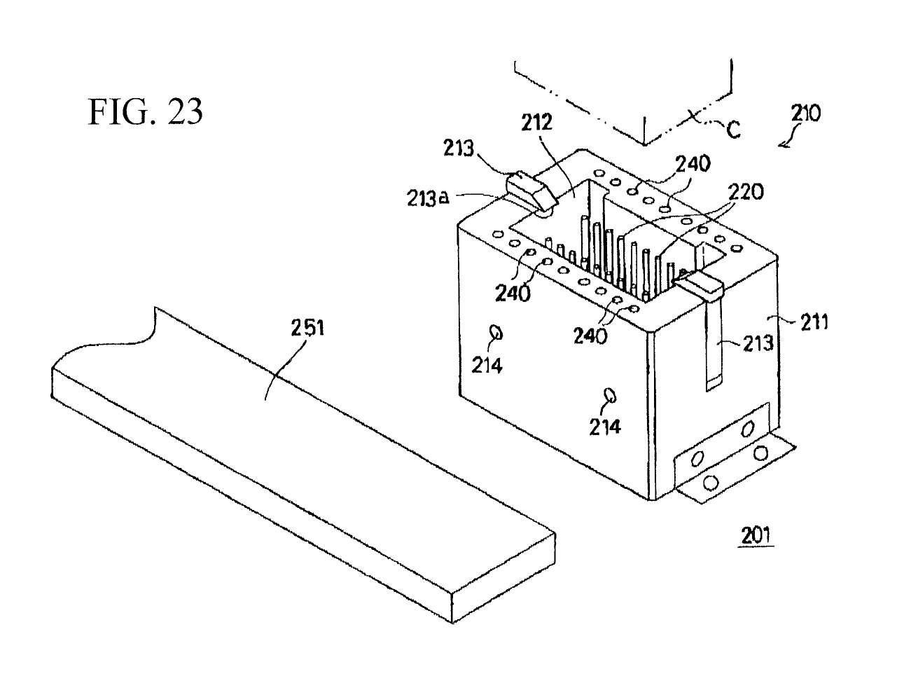

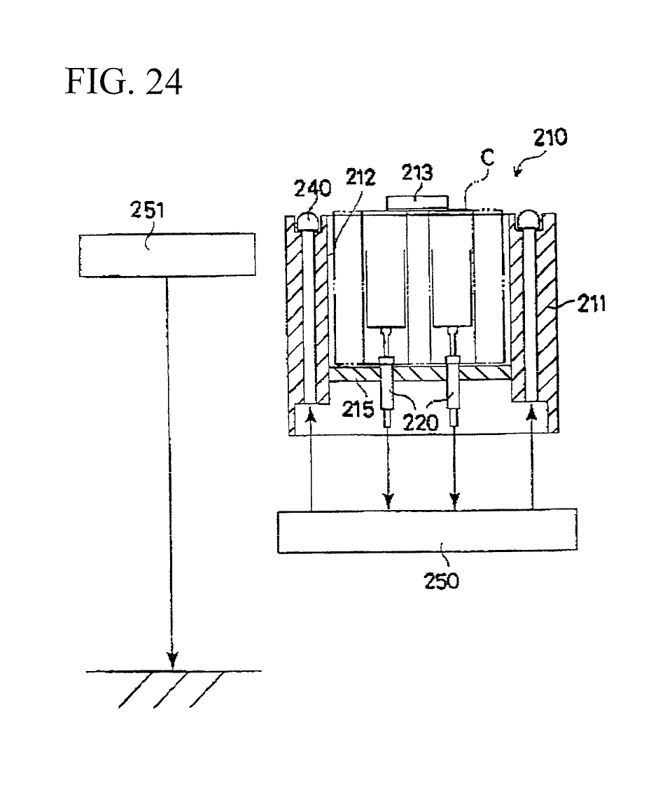

The board unit B is provided with a board 201 fixed to the board frame 112 of the push carriage 110 and the terminal insertion assisting units 210 on the board 201, as shown in FIGS. 23 and 24. Each insertion assisting unit 210 includes a plurality of connector holders 211 in the board unit B and the wire supplying table 300.

Each connector holder 211 has a substantially rectangular parallelepiped outer configuration. A bottomed connector accommodating portion 212 is open in the upper surface of each connector holder 211 and conforms with the outer configuration of a connector C (shown only in phantom line in FIGS. 23 and 24). As shown in FIG. 23, the connector holders 211 take various shapes and correspond to the number of contacts and the shape of the connectors C to be held. The connector holders 211 are arranged to accommodate connectors C in the corresponding connector accommodating portions 212 and to connect the ends of terminal-mounted wires W with connectors mounted in the respective connector holders 211. Locks 213 are provided at the sides of the connector holder 211 and pivot about pins 214. Unillustrated elastic members keep the locks 213 in positions where locking claws 213a of the locks 213 engage the upper surface of the connector C and keep the connector C in the respective holder 211. The respective connector holders 211 are arranged in an order substantially corresponding to an arrangement order at the main line ML. Thus, the subassembly M produced by a connecting step can be transferred efficiently to the main line ML while maintaining its layout mode.

A probe holding plate 215 is fixed at the bottom of the connector accommodating portion 212 of each connector holder 211 and holds probes 220, as shown in FIG. 24. The probe holding plate 215 also defines a placing surface for receiving the bottom of the connector C in the connector accommodating portion 212. The probe described in EP 00 114 921.0 may be used as a probe in connection with the present invention. The probes 220 are provided preferably in one-to-one correspondence with the contacts of the connector held by each connector holder 211. Thus, the respective probes 220 enter the cavities of the connector C inserted into the connector accommodating portion 212 and connect with the terminals of the terminal-mounted wires W that are inserted into the cavities.

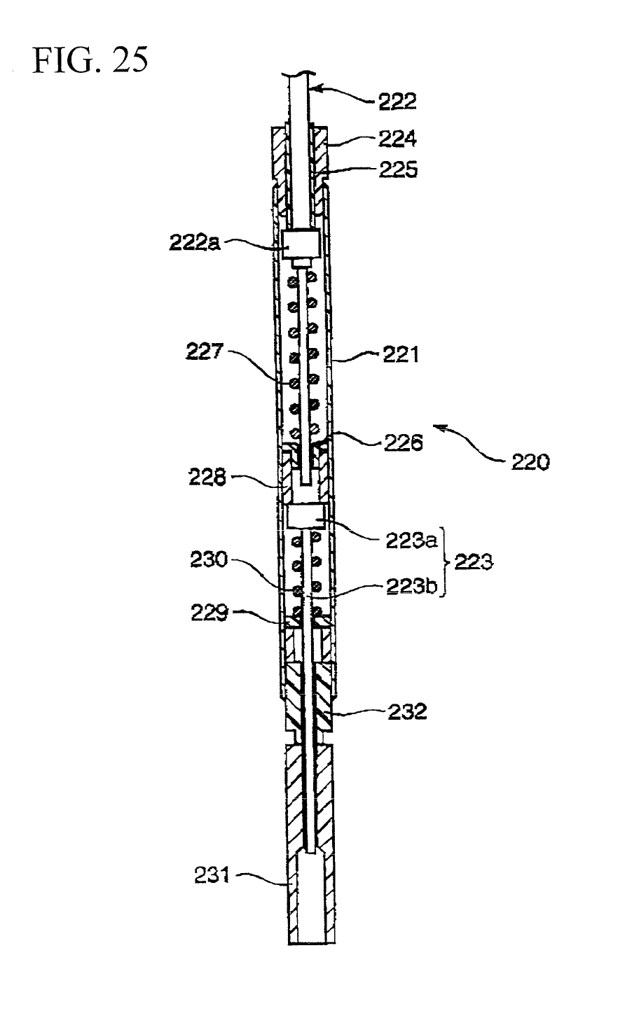

The probe 220 includes a sleeve 221 made e.g. of a metallic material and upper and lower rods 222, 223 loosely fitted in the sleeve 221, as shown in FIG. 25. The sleeve 221 is grounded electrically by metal plating applied to the probe holding plate 215 (see FIG. 24). The rods 222, 223 are both substantially bar-shaped metallic members. The upper rod 222 is mounted at the upper end of the sleeve 221 via a collar 224 and an insulating collar 225 secured to the inner circumferential surface of the collar 224. An upper portion of the rod 222 projects up beyond the sleeve 221. A flange 222a integrally or unitarily bulges out in an intermediate position of the upper rod 222 and faces the bottom surface of the insulating collar 225. Contact of the flange 222a with the bottom surface of the collar 225 prevents the upper rod 222 from coming up and out of the sleeve 221. A ring-shaped spring sheet 226 made of an insulating material is secured at an intermediate position of the sleeve 221, and a coil spring 227 is provided between the spring sheet 226 and the flange 222a to bias the rod 222 upward. In addition, the bottom end of the upper rod 222 extends through the spring sheet 226 to face the lower rod 223.

The lower rod 223 has a large-diameter head 223a and a small diameter stem 223b that are concentric with one another. The head 223a faces a tubular conductive stopper 228 that is continuous with the bottom of the spring sheet 226. A spring sheet 229 made of an insulating material is secured to the inner circumferential surface near the bottom of the sleeve 221, and a coil spring 230 is provided between the spring sheet 229 and the head 223a. As a result, the lower rod 223 normally is pushed against the conductive stopper 228 by the coil spring 230 and is grounded electrically via the conductive stopper 228 and the sleeve 221. On the other hand, the head 223a faces the bottom end of the upper rod 222. As described later, the upper rod 222 can be pushed down, and the bottom end of the upper rod 222 contacts the head 223a of the lower rod 223 to disconnect the lower rod 223 from the conductive stopper 228.

A connection sleeve 231 is provided for connecting a lead wire. The connection sleeve 231 is fixed to the bottom of the sleeve 221 via an insulating sleeve 232. The stem 223b of the lower rod 223 is vertically displaceable and held in sliding contact with the inner circumferential surface of the connection sleeve 231 for electrical connect.

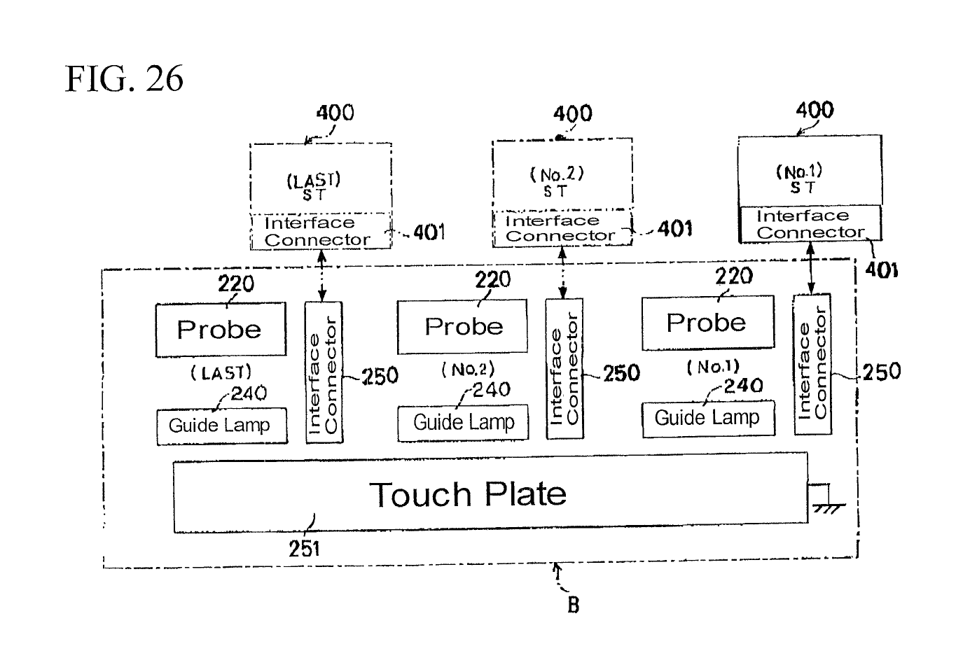

The connector holder 211 is provided with guide lamps 240, as shown in FIGS. 23 and 24, that correspond to the contacts of the connector C. The guide lamps 240 preferably are light-emitting diodes and are connected with wire connection instructing mechanisms 400 by a interface connectors 250, as shown in FIG. 26. In the illustrated embodiment, an electrically grounded touch plate 251 is mounted on the board 201. Alternatively, the touch plate 251 may be at a specified voltage different from 0 V.

As shown in FIG. 26, the probes 220 are sorted into groups for each station ST to which the push carriage 110 is conveyed, and the interface connectors 250 for the respective groups are connected with the probes 220. The respective interface connectors 250 preferably have different connection ports to prevent an erroneous connection among the respective stations ST. The grouped probes 220 are not necessarily located in the same connector holder 211, but are grouped among different connector holders 211. Connection instruction and electrical connection test of the terminal-mounted wires W can be made by connecting the interface connectors 250 with interface connectors 401 of the wire connecting instructing mechanisms 400 on the respective wire supplying tables 300.

The terminal insertion assisting units 210 on the board 201 of the board unit B are sorted into groups G, as shown in FIG. 1. The groups G correspond to the respective branch wires in a layout of the subassembly M when the subassembly M is arranged on the wire laying board 11 of the main line ML. The groups G are based on an operation procedure at the time of gross assembling. Specifically, the wire laying board 11 of the main line ML may be moved in a conveying direction indicated by an arrow AW1. An operator then can conduct individual operations efficiently while standing substantially at a fixed position if he conducts operations in a direction AW2 opposite from the conveying direction AW1 of the wire laying board 11 of the main line ML. Accordingly, work areas of the operator on the wire laying board 11 of the main line ML are divided for the respective branch wires from an upstream side of the conveying direction AW1, and the terminal insertion assisting units 210 corresponding to the connectors of the corresponding groups G are arrayed from the left side to the right side of FIG. 20. The groups G are distinguished by coloring the respective terminal insertion assisting units 210 in different colors or inscribing partitioning lines on the board 201 for the respective groups G.

The terminal insertion assisting units 210 corresponding to a connector group arranged below the main wire M on the wire laying board are classified as another group F. Wires corresponding to the group F are not held by a subassembly device 500, but preferably by a temporarily holding and/or transferring device 500 described later.

The connectors are sorted into groups G for the respective branch wire portions based on an operation procedure on the wire laying board 11 of the main line ML, and the connectors (terminal insertion assisting units 210) corresponding to the respective groups G are arranged. Accordingly, the final modes of the respective branch wire portions can be maintained by the layout of the terminal insertion assisting units 210. As a result, it is not necessary to lay the respective wires W in their final modes, and a relatively large subassembly (having, for example, 100 circuits and 26 connectors) can be produced easily without getting the wires entangled. Further, this way of producing the subassembly makes the previous insertion rate maximally approximate to 100%.

The respective wires W need not be arranged in the final modes and the modes of the respective branch wire portions can be maintained only by connecting the respective wires W with the connectors C. Thus, a wire laying step repeated in prior art methods can be eliminated, thereby making the overall production process of wiring harnesses significantly more efficient.

The final modes of the subassemblies M can be made smaller by sorting and arraying the respective connectors C for the respective branch wires. Thus, even in the case of producing a large subassembly M, connecting operations for the subassembly M can be performed within a small work area by arraying the connector C in a concentrated manner. Therefore, operability can be improved in this respect as well.

The board unit B is provided with the temporarily holding device 500 for temporarily holding wires W for the respective groups G, as described above and as illustrated in FIGS. 2, 3 and 8. Accordingly, as described and illustrated above, the subassembly M produced on the board unit B can be transferred to the wire laying board 11 of the main line M by the temporary holding device 500.

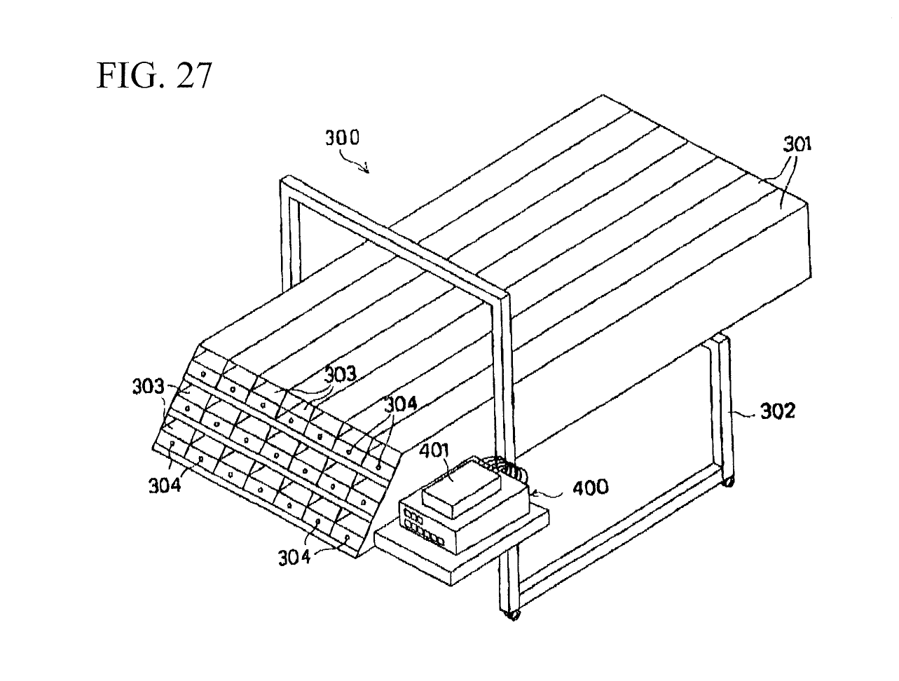

With reference to FIG. 27, the wire supplying table 300 is constructed by mounting an assembly of substantially rectangular tubes or receptacles 301 that are arranged next to each other at several stages on a frame 302. The tubes 301 have openings 303 that face an operator and extend obliquely downward. Additionally, the tubes 301 are inclined on the frame 302 such that the sides with the openings 303 are lower than the opposite side.

The respective tubes 301 are adapted to stock a plurality of kinds of terminal-mounted wires W, with each kind being stocked in one tube 301. The guide lamps 304 are mounted in one-to-one correspondence with the respective openings 303. Illumination of the appropriate guide lamp 304 specifies the kind of terminal-mounted wire W to be taken by the operator.

Each wire supplying table 300 is provided with a wire connection instructing mechanism 400 in which wire connection data corresponding to this wire supplying table 300 are registered. The wire connection instructing mechanism 400 is provided with the interface connector 401 corresponding to the interface connectors 250 on the board of the board unit B, and is connected electrically with the terminal insertion assisting units 210 on the board unit B via the interface connector 401.

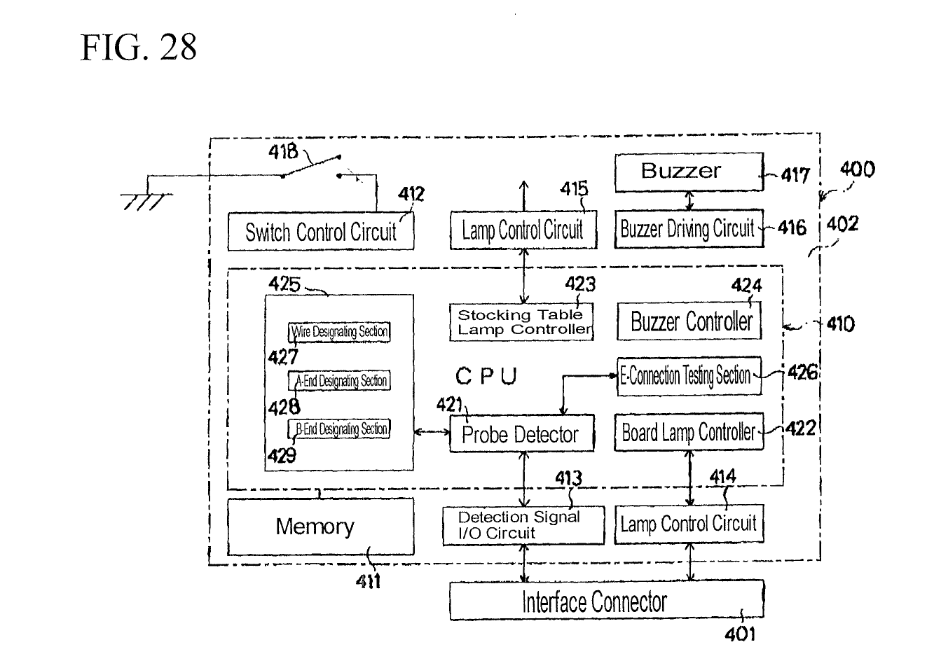

With reference to FIGS. 27 and 28, the wire connection instructing mechanism 400 has a casing 402 separate from the interface connector 401. A CPU 410, a memory 411, various control circuits 412 to 416 and a buzzer 417 connected with the CPU 410 are provided in the casing 402. The casing 402 has switches 418 in the form of push buttons. For example, an external power supply is turned on and off, various modes are switched and the product number of the subassembly to be produced is changed by operating these switches 418.

The CPU 410 operates in accordance with a specified software program stored beforehand in the memory 411. The CPU 410 includes a probe detector 421 for detecting a voltage state of the probe 220 corresponding to the terminal-mounted wire W to be selected, a board lamp controller 422 for controlling the guide lamps 240, a stocking table lamp controller 423 for controlling the guide or instruction lamps 304 of the wire supplying table 300, a buzzer controller 424 for controlling the buzzer 417, a guide instructing unit 425 for controlling the guide of the terminal-mounted wire W, and an electrical connection testing section 426 for testing an electrical connection of the connected terminal-mounted wire W.

The probe detector 421 is connected with a detection signal input/output (I/O) circuit 413, which is connected with the probes 220 via the interface connectors 401, 250 to detect the voltage of the probe 220 corresponding to the terminal-mounted wire W to be selected. Although not specifically shown here, a detection current flows via a pull-up resistor between the detection signal I/O circuit 413 and the interface connector 401. If the lower rod 223 of the probe 220 is disconnected from the ground, the voltage of the lower rod 223 increases and the voltage detector 421 detects such a change by detecting a voltage difference.

The board lamp controller 422 is connected with a lamp control circuit 414, which is connected with the guide lamps 240 of the board unit B via the interface connectors 401, 250 to selectively turn on the guide lamp 240 corresponding to the terminal-mounted wire W to be selected.

The stocking table lamp controller 423 is connected with a lamp control circuit 415, which is connected with the guide lamps 304 of the corresponding wire supplying table 300 to illuminate the guide lamp 304 corresponding to the terminal-mounted wire W to be selected.

The buzzer controller 424 is connected with a buzzer driving circuit 416 so as to drive the buzzer 417 via the buzzer driving circuit 416.

The instructing unit 425 includes a wire instructing section 427 for instructing an operator which the terminal-mounted wire W is to be selected from the wire supplying table 300, an A-end instructing section 428 for executing a connection instructing step for one end of the terminal-mounted wire W, and a B-end instructing section 429 for executing a connection instructing step for the other end of the terminal-mounted wire W. The connection instructing step described later is performed by these sections.

The electrical connection testing section 426 has a function of checking whether each of the connected A-end and B-end of the terminal-mounted wire W is correct based on the information registered beforehand in the memory 411, and tests the electrical connection of all the circuits when all the terminal-mounted wires W relating to the corresponding station ST are connected.

With reference to FIG. 29, the board units B are successively and intermittently conveyed from upstream stations ST to downstream stations ST by the elevating carriage conveying apparatus 100 at the subassembly line SL by being pushed by hand as described above. The subassembly M to be produced may require an option. In this situation, an option module OM stocked in the option station OS is mounted on the board unit B. A subassembly including an option circuit can be produced by connecting the terminal-mounted wire W with the option module OM.

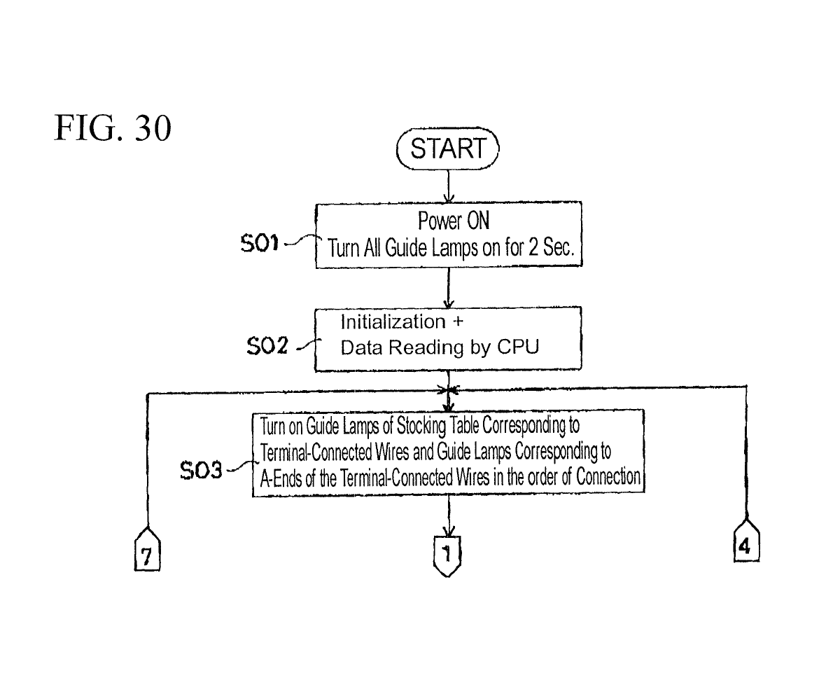

The respective, preferably all connectors C necessary to produce the subassembly M are mounted in the respective connector holders 211 arranged on the board unit B. Subsequently, the interface connector 401 of the wire connection instructing mechanism 400 at the first station ST is connected with the interface connectors 250 of the corresponding board unit B, a main power supply is turned on (Step S01 of FIG. 30) by turning on one of the switches 418. At this stage, the CPU 410 of the wire connection instructing mechanism 400 drives all the lamp control circuits 414, 415 shown in FIG. 28 to turn all the corresponding guide lamps 240, 304 on for, e.g. 2 sec. In this way, an operator can check whether the guide lamps 240, 304 are in proper condition and confirm abnormality of the guide lamps 240, 304 before the connecting operation.

After power application, the CPU 410 performs initialization, reading of data and various settings as shown in Step S02 of FIG. 30.

Upon completion of the initialization, the instructing unit 425 and the lamp controllers 422, 423 in the CPU 410 are operate. Additionally; the lamp control circuits 414, 415 are driven to turn on the guide lamp 304 corresponding to the first terminal-mounted wire W and the guide lamp 240 of the connector holder 211 with which the A-end of this terminal-mounted wire W is to be connected, as shown in Step S03 of FIG. 30. In response to the turned-on lamps 304, 240, the operator takes the terminal-mounted wire W from the tube 301 corresponding to the turned-on guide lamp 304 and connects the A-end thereof with the connector C in the connector holder 211 indicated by the guide lamp 240.

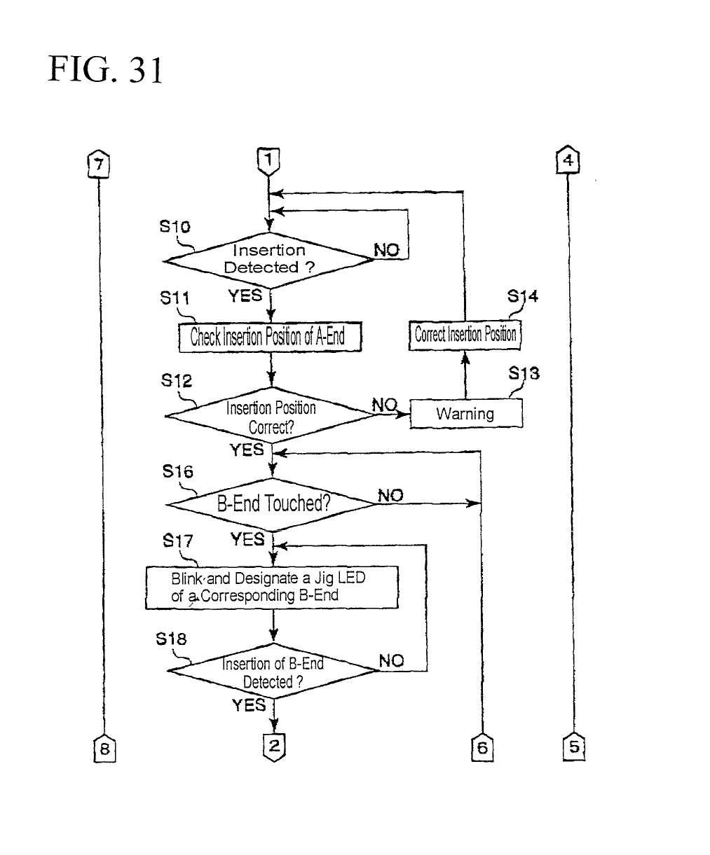

As shown in Step S10 of FIG. 31, the CPU 410 waits on standby for the insertion of the A-end of the terminal-mounted wire W after the guide lamps 304, 240 are turned on. This discrimination is made by detecting a voltage change in the corresponding probe 220. Specifically, when the terminal T of the terminal-mounted wire W is inserted into a cavity of the connector C, the terminal T pushes the upper rod 222 of the probe 220 to displace the lower rod 223 down. Accordingly, the lower rod 223 is disconnected electrically from the sleeve 221 and disconnected from the ground. As a result, the detection signal I/O circuit 413 can detect the connection of the A-end by detecting a change in the voltage of the lower rod 223 which is increased by the detection current.

Upon connection of the A-end, the electrical connection testing section 426 of the CPU 410 checks whether the A-end of the terminal-mounted wire W is connected with the proper contact at this stage as shown in Steps S11, S12 of FIG. 31. If the terminal-mounted wire W is not connected with the proper contact, the buzzer controller 424 of the CPU 410 drives the buzzer driving circuit 416 to operate the buzzer 417, thereby notifying the operator of an erroneous connection (Step S13). In such a case, Step S10 follows after the terminal-mounted wire W is reinserted in a proper position (Step S14).

If the A-end is connected properly, Step S16 of FIG. 31 follows to wait until the operator brings the B-end of the terminal-mounted wire W having its A-end connected into contact with the touch plate 251. In other words, a next operation step does not follow until the opposite ends of the taken-out terminal-mounted wire W are connected since each of the opposite ends of all the terminal-mounted wires W is connected with a connector C.

Step S17 of FIG. 31 follows if the operator brings the B-end into contact with the touch plate 251, and the voltage of the probe 220 corresponding to the A-end decreases again. This enables the B-end instructing section 429 of the CPU 410 to specify the guide lamp 250 to be turned on. Accordingly, the board lamp controller 422 controls the lamp control circuit 414 to turn on the corresponding guide lamp 250. Step S18 involves waiting until the terminal T at the B-end is connected.

The operator observes the illuminated guide lamp 250 and inserts the terminal T at the B-end into a corresponding cavity of the connector C. An output voltage of the probe 220 corresponding to the terminal T at the B-end changes similar to the case of the A-end. Thus, the CPU 410 can discriminate the connection of the terminal T at the B-end and the position of connection.

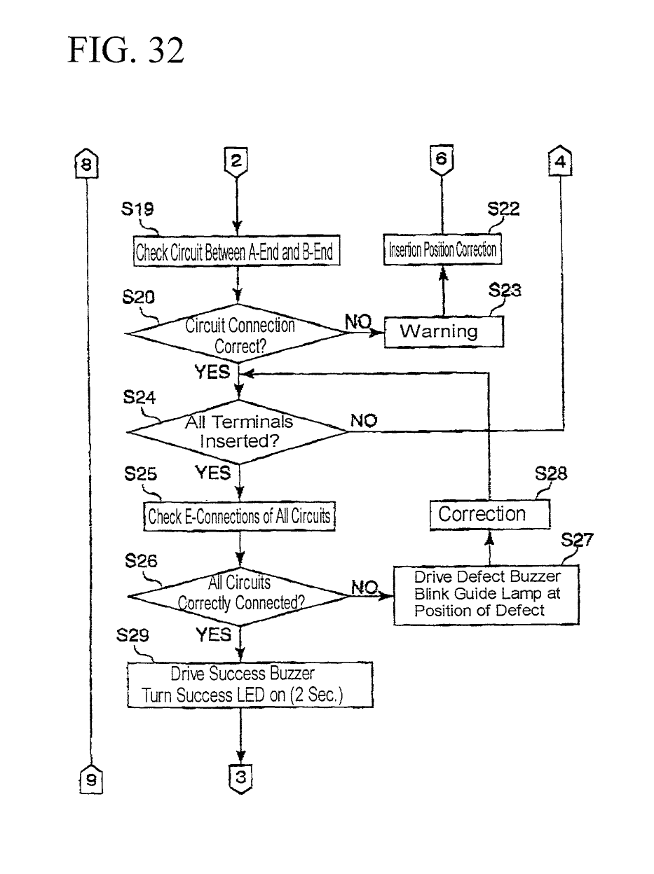

When the terminal T at the B-end is connected, the electrical connection testing section 426 of the CPU 410 conducts an electrical connection test of the connected terminal-mounted wire W in Steps S19, S20 of FIG. 32. If the connected state of the terminal-mounted wire W should differ from a proper state stored beforehand in the memory 411, an error is notified by means of the buzzer 417. In response thereto, the operator corrects the connection of the B-end (Step S22).

On the other hand, upon judging that the connection of the B-end is proper, the CPU 410 drives the lamp control circuit 414 to blink the guide lamp 250 corresponding to the completely connected terminal-mounted wire W. Then in Step S24 of FIG. 36, the CPU 410 discriminates whether insertion of all the terminals has been completed. If terminal-mounted wires W still remain to be connected, the aforementioned procedure is repeated after returning to Step S03 of FIG. 30.

On the other hand, upon completion of the insertion of all the terminal-mounted wires W, an electrical connection test is conducted for all circuits formed by all the connected terminal-mounted wires W in Steps S25 and S26 of FIG. 32.

In this electrical connection testing step, the CPU 410 controls the detection signal I/O circuit 413, and the connected states of the circuits are tested by reducing the output voltages of the respective probes 220 corresponding to the A-end side to the ground voltage or other specified voltage one by one and checking the output voltages of the corresponding probes 220 at the B-end side. If an erroneous connection is detected, an error is notified by activating the buzzer 417 and blinking the corresponding guide lamp 240 (Step S27) and the operator corrects the connection based on the error notification (Step S28).

On the other hand, upon passing the electrical connection test, a success notification is made by means of the buzzer 417 in Step S29. The success and failure notifications may be made distinguishable by setting one to be a long buzzing sound while setting the other to be a short buzzing sound and/or by changing the buzzing tone or frequency of the buzzing sound.

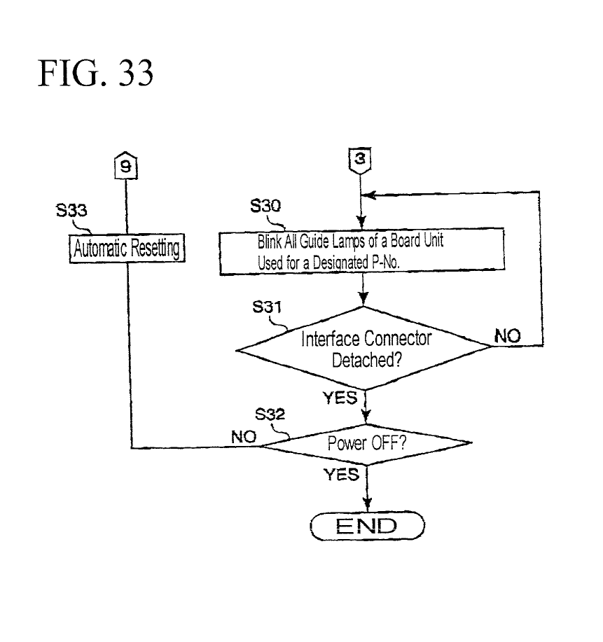

Upon completion of the electrical connection test, the operator detaches the interface connector 401 from the board unit B and moves the push carriage 110 to the next station ST. The CPU 410 waits on standby until the interface connector 401 is detached after blinking all the guide lamps 250 in Step S30 of FIG. 33. After the interface connector 410 is detached, this flow returns to Step S03 after automatic resetting unless the main power supply has been turned off (Step S32).

The operator moves the push carriage 110 to the next station ST in the procedure described with reference to FIG. 21 and connects the interface connector 401 of the wire connection instructing mechanism 400 of this station ST with the corresponding interface connector 250 to repeat the wire connecting step. Since the interface connectors 401, 250 having different connection ports for the respective stations ST are used in the illustrated embodiment, the operator will not make any erroneous connection. By repeating the aforementioned connecting operation at the respective stations ST, a relatively large subassembly M can be produced directly from the terminal-mounted wires W.

As described above, according to this embodiment, the subassemblies M having a previous insertion rate of up to 100% can be produced from the terminal-mounted wires W and are directly gross-assembled into a final wiring harness. Succeeding operation steps that depend on the manual operations of the operators can be reduced as much as possible. Therefore, operational efficiency can be improved and an erroneous connection will not occur. Further, there is no operation of inserting terminal at a later stage. Accordingly, an operation of laying wires on the same wire arrangement path can also be eliminated, thereby maximally improving a wire laying efficiency. Thus, this embodiment has a significant effect of maximally improving a production efficiency.

The aforementioned embodiment is merely an illustration of a preferred specific example of the present invention, and the present invention is not limited thereto. It should be appreciated that various other changes can be made without departing from the scope of the present invention as claimed.

As described above, the operation step repeated in the conventional methods can be eliminated from the production process of the subassembly to enable production of large subassemblies. This brings about a remarkable effect of making the production process of the wiring harness significantly more efficient.

What is claimed is:

1. A wiring harness producing method for producing subassemblies (M) of a wiring harness in advance and then producing the wiring harness as a final form by arranging the produced subassemblies (M) on a wire laying board (11) of a main line (ML), comprising the steps of:
producing the subassemblies (M) on at least one board (201) of subassembly lines (SL) in compressed modes on the wire laying board (11) of the main line (ML),
temporarily holding the subassemblies (M) in the compressed modes, and
arranging the temporarily held subassemblies (M) on the wire laying board (11) of the main line (ML) and developing the compressed modes (FIG. 11) into final modes (FIG. 12).

2. A subassembly device (500; 700) for temporarily holding and transferring a subassembly (M) produced on at least one board (201) of a subassembly line (SL) in a compressed mode and transferring the subassembly (M) to a wire laying board (11) of a main line (ML) and converting the subassembly (M) to an uncompressed layout mode, comprising:
a carrier (501) detachably mountable on the board (11), and
temporary holding members (510) on the carrier (501) for temporarily holding the subassembly (M) in the compressed mode, the temporarily holding members (510) displaceable on the carrier (501) so that the temporarily held subassembly (M) can be developed from its compressed mode (FIG. 11) to the layout mode (FIG. 12) on the wire laying board (11).

3. A subassembly device (500; 700) according to claim 2, wherein the respective temporary holding members (510) are coupled to each other by a coupling mechanism (520; 720) displaceable in directions for selectively moving the temporary holding members (510) toward and away from each other.

4. A subassembly device according to claim 3, wherein the coupling mechanism (520; 720) comprises a plurality of slidable pieces (721) having the substantially same specifications, being slidably mounted along the carrier (501), and a coupling member (731) for coupling the respective slidable pieces (721) to freely extend and contract, the temporarily holding members (510) being selectively detachably fixed to the respective slidable pieces (721).

5. A subassembly transferring device according to claim 4, wherein the slidable pieces (721) conform in number to a subassembly (M) having a maximum number of wires among a multitude of kinds of subassemblies (M) to be produced.

6. A cover board (85) for use with a wire laying board (11) with wire holders (11a) for arranging a subassembly (M) produced by assembling a plurality of wires, the cover board (85) being detachably provided on the wire laying board (11) to substantially cover certain wire holders (11a) which are not needed for arranging the subassembly (M) so as to receive portions of the subassembly (S) arranged on the wire laying board (11).

7. A cover board (85) according to claim 6, wherein the cover board (85) comprises an exposing portion (88) for exposing selected ones of the wire holders (11a) necessary to arrange the subassembly (M) is provided.

8. A wire laying board (11) for a wiring harness, comprising:
detachable members (82) for detachably holding a subassembly device (500), and
standing members (81) for holding the detachable members (82) in elevated positions above a wire laying height defined by wire holders (11a) to arrange the subassembly (S) from the subassembly device (500) held by the detachable members (82).

9. The wire laying board (11) of claim 8, further comprising:
a plurality of wire holders (11a) for arranging a subassembly (M) produced by assembling a plurality of wires,
at least one cover board (85) for covering selected ones of the wire holders (11a) that are not needed, and
at least one mounting member (85a) for mounting the cover board (85) on a main body of the wire laying board (11) such that the cover board (85) is displaceable between a covering position (FIG. 9A) where the cover board (85) substantially covers the certain wire holders (11a) and an exposing position (FIG. 9B) where the cover board (85) exposes all of the wire holders (11a).

10. A wire laying board according to claim 9, further comprising a holding member (86; 87) for holding the cover board (85) in the covering position (FIG. 9A).

11. A wiring harness producing method, according to claim 1, for producing a subassembly (M) having a plurality of branch wires and connectors (C) connected with ends of the branch wires at a subassembly line (SL) in advance and then arranged on a wire laying board (11) of a main line (ML) to produce a processed wiring harness, comprising the steps of:
sorting the respective branch wires into a plurality of groups (G; F) based on an operation procedure at the main line (ML),
sorting out the connectors (C) corresponding to the respective branch wires for the respective groups (G; F) and arranging them on connector holders (211),
connecting the corresponding wires with the arranged connectors (C), and
temporarily holding the connected wires for the respective groups (G; F) of the branch wires preferably with a subassembly device (500) for temporarily holding and transferring the subassembly (M).

12. An apparatus for producing a subassembly (M) having a plurality of branch wires and connectors (C) connected with ends of the branch wires to produce a wiring harness at a main line (ML), comprising:
at least one board (201) on which a connecting operation for the subassembly (M) is performed,
connector holders (211) on the board (201) and adapted to hold the connectors (C) that will produce the subassembly (M), and
a wire connection instructing mechanism (400) for instructing wires to be connected with contacts of the connector (C) held in each connector holder (211),
wherein the connector holders (211) are arranged to sort out the connectors (C) for the respective groups (G; F) of the branch wires based on an operation procedure at the main line (ML).

13. An apparatus according to claim 12, further comprising a subassembly device (500) to be mounted on the board (201) and adapted to temporarily hold the respective wires connected with the connectors (C) with the wires remained sorted out for the respective groups (G; F) of the branch wires.

14. An apparatus according to claim 13, wherein the subassembly device (500) is detachable so that the produced subassembly (M) can be detached from the board (201) while being held andr transferred from the board (201) of the subassembly line (SL) to the wire laying board (11) of the main line (ML).
